(19) United States
(12) Patent Application Publication
(10) Pub. No.: US 2021/0256665 A1
(43) Pub. Date: Aug. 19, 2021

(54) GENERATION APPARATUS, GENERATION METHOD, AND STORAGE MEDIUM

(71) Applicant: CANON KABUSHIKI KAISHA, Tokyo (JP)

(72) Inventors: Kazuyuki Furusawa, Tokyo (JP); Ryosuke Mizuno, Tokyo (JP)

(21) Appl. No.: 17/168,292

(22) Filed: Feb. 5, 2021

(30) Foreign Application Priority Data
Feb. 18, 2020 (JP) 2020-025037
Dec. 17, 2020 (JP) 2020-209189

(51) Int. Cl. G06T 5/00; G01C 3/08

(52) U.S. Cl. CPC G06T 5/006; G06T 2207/20221; G06T 2207/10028; G01C 3/085

(57) ABSTRACT

The present invention can reduce a memory bandwidth required for calculation of distance information. Provided is a generation apparatus that generates a range image indicating a distance to a subject. The generation apparatus includes: a generation unit that generates the range image based on a pair of captured images with parallax; and a correction unit that corrects distortion, caused by an optical system of an image capturing unit generating the pair of captured images, in a region of the range image, the region being a region in which reliability is a predetermined threshold or more.

### BACKGROUND OF THE INVENTION

### Field of the Invention

The present invention relates to a distance measuring technique of calculating a distance to a subject.

### Description of the Related Art

In recent years, distance measuring techniques are used in various applications such as autonomous driving and factory automation (FA) and there are various distance measuring techniques. The distance measuring techniques include, for example, a technique of using images captured by a stereo camera. In this method, a subject is simultaneously captured from different directions with multiple image capturing devices by using the stereo camera and information on a distance to the subject is calculated based on parallax between multiple obtained captured images (Japanese Patent Laid-Open No. 2018-105682).

Moreover, as another distance measuring technique, there is a technique in which pixels (distance measuring pixels) having a distance measuring function are arranged as some or all of the pixels in one image sensing element and a distance to a subject is calculated by using a phase difference method (Japanese Patent No. 51920%). In this method, multiple photodiodes are arranged in each distance measuring pixel to generate separate captured images (referred to as A image and B image), respectively, and the distance to the subject is calculated based on a positional difference amount between the captured images.

Furthermore, there is a distance measuring method that uses no image sensing element. For example, in a time of flight (TOF) method, a distance to a subject is measured by irradiating a subject with light and detecting time it takes for light to reflect on the subject and return.

In distance measuring apparatuses using these distance measuring techniques, distortion due to optical factors occurs. For example, in a distance measuring apparatus using an image sensing element, distortion occurs in a captured image due to distortion aberration of a lens. In the case where a range image is generated by calculating a distance based on the captured image including the distortion, the distortion occurs also in the range image. Accordingly, distortion correction is generally performed on the captured image and the range image is generated based on the image subjected to the distortion correction. Alternatively, the distortion correction is performed on the generated range image.

There are various distortion correction methods and all methods need to refer to a pixel value of a pixel in a pre-correction image that corresponds to each pixel in a post-correction image and to pixel values of pixels around this pixel.

However, a correction method with higher accuracy requires a greater memory bandwidth in reading of the pixel values of the pre-correction image from a memory for the distortion correction. Accordingly, calculation of highly accurate distance information has a problem of an increase in the memory bandwidth and occurrence of memory bandwidth shortage.

### SUMMARY OF THE INVENTION

One aspect of the present invention provides a generation apparatus that generates a range image indicating a distance to a subject, the generation apparatus including: a generation unit configured to generate the range image based on a pair of captured images with parallax; and a correction unit configured to correct distortion, caused by an optical system of an image capturing unit generating the pair of captured images, in a region of the range image, the region being a region in which reliability is a predetermined threshold or more.

Further features of the present invention will become apparent from the following description of exemplary embodiments with reference to the attached drawings.

### BRIEF DESCRIPTION OF THE DRAWINGS

FIG. 1 is a diagram representing a relationship between FIGS. 1A and 1B;

FIGS. 1A and 1B are a diagram illustrating a configuration of a distance measuring apparatus in Embodiment 1;

FIG. 2 is a diagram illustrating a process flow in Embodiment 1:

FIG. 3A is a view illustrating an example of a received image in Embodiment 1;

FIG. 3B is a view illustrating an example of the received image in Embodiment 1;

FIG. 4 is a diagram illustrating an example of information on bandwidths required for distortion correction methods in Embodiment 1;

FIG. 5A is a diagram explaining a distortion correction method in Embodiment 1;

FIG. 5B is a diagram explaining a distortion correction method in Embodiment 1;

FIG. 6 is a diagram representing a relationship between FIGS. 6A and 6B;

FIGS. 6A and 6B area diagram illustrating a configuration of a distance measuring apparatus in Embodiment 2;

FIG. 7 is a diagram illustrating a process flow in Embodiment 2:

FIG. 8 is a diagram representing a relationship between FIGS. 8A and 8B;

FIGS. 8A and 8B are a diagram illustrating a configuration of a distance measuring apparatus in Embodiment 3;

FIG. 9 is a diagram illustrating a configuration of a cache in Embodiment 3;

FIG. 10 is a view for explaining reliability in Embodiment 3;

FIG. 11 is a diagram explaining a distortion correction process in Embodiment 3;

FIG. 12 is a diagram representing a relationship between FIGS. 12A and 12B:

FIGS. 12A and 12B are a diagram illustrating a configuration of a distance measuring apparatus in Embodiment 4;

FIG. 13A is a diagram illustrating an example of bandwidth information of a distortion correction method in Embodiment 4:

FIG. 13B is a diagram illustrating an example of bandwidth information of additional processes in Embodiment 4;

FIG. 14 is a diagram representing a relationship between FIGS. 14A and 14B:

FIGS. 14A and 14B are a diagram illustrating a configuration of a distance measuring apparatus in Embodiment 5;

FIG. 15 is a diagram illustrating an example of a process flow in Embodiment 5;

FIG. 16 is a diagram explaining an image shape transformation process method in Embodiment 5;

FIG. 17 is a diagram representing a relationship between FIGS. 17A and 17B;

FIGS. 17A and 17B are a diagram illustrating a configuration of a distance measuring apparatus according to Embodiment 6;

FIG. 18 is a diagram representing a relationship between FIGS. 18A and 18B;

FIGS. 18A and 18B are a diagram illustrating another example of the configuration of the distance measuring apparatus according to Embodiment 6:

FIG. 19 is a diagram illustrating an example of a process flow in Embodiment 6; and

FIG. 20 is a diagram illustrating an example of a process flow in Embodiment 7.

### DESCRIPTION OF THE EMBODIMENTS

An embodiment of a distance measuring apparatus of the present invention is described below by using the drawings. The following embodiments are described while giving a method using a stereo camera and a method in which multiple photodiodes are arranged for one distance measuring pixel and a distance is calculated by using a phase difference method, as examples of a distance measuring method. However, distance measuring methods to which the present invention can be applied are not limited to these methods. The present invention can be applied to all distance measuring apparatuses in which distortion due to optical systems occurs such as an apparatus using TOF. Moreover, although a storage destination of a captured image and a range image is a dynamic random access memory (DRAM) in the embodiments, the storage destination may be other memories. In such a case, bandwidth information corresponding to the memory being the storage destination of the range image needs to be provided as information on memory bandwidths required in the respective types of distortion correction to be described later.

### Embodiment 1

A distance measuring apparatus according to Embodiment 1 of the present invention is described. Embodiment 1 employs a method in which multiple photodiodes are arranged at intervals of several μm for one distance measuring pixel and distance calculation using the phase difference method is performed on paired captured images with parallax that are generated by an image capturing device including at least one optical system common to the captured images. In the case where two paired captured images are obtained from one optical system as describe above, distortion amounts of the two captured images are close to each other. Accordingly, a configuration in which a range image is first generated from the two captured images and then the distortion is corrected is preferable. In this configuration, the distortion correction needs to be performed only on one range image. Accordingly, a DRAM access bandwidth (DRAM bandwidth) required for reading of pixel values relating to the distortion correction can be reduced from that in the case where the distortion correction is performed on the paired captured images.

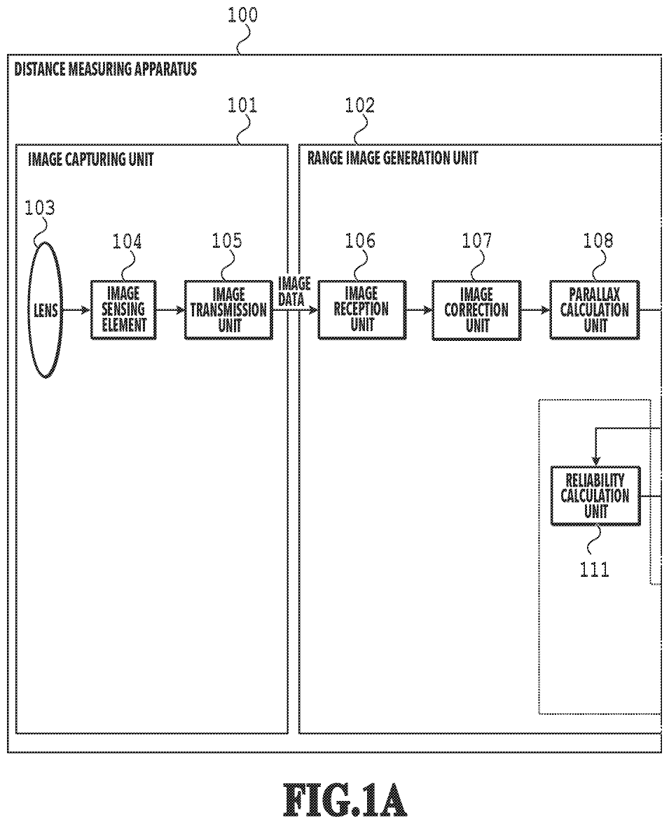

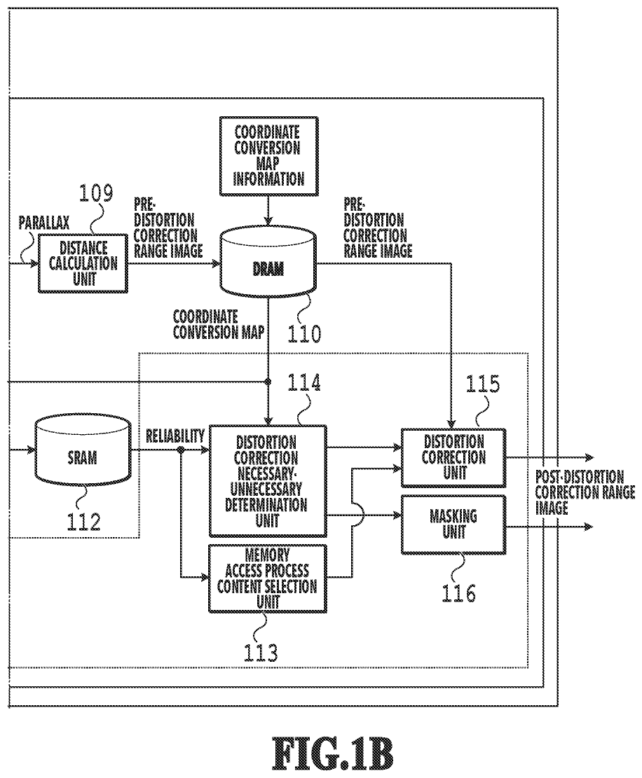

FIGS. 1A and 1B are a hardware configuration diagram of the distance measuring apparatus according to Embodiment 1. Reference numeral 100 denotes the distance measuring apparatus of the embodiment that generates a range image of a subject subjected to distortion correction. Reference numeral 101 denotes an image capturing unit that captures an image of the subject and generates image data. Reference numeral 102 denotes a range image generation unit that receives the image data from the image capturing unit 101 and generates the range image.

Next, an internal configuration of the image capturing unit 101 is described. Reference numeral 103 denotes a lens that focuses light reflected on the subject and guides the light to an image sensing element 104 to form an image on an image sensing surface. Reference numeral 104 denotes the image sensing element that is an image sensor such as a CMOS sensor or a CCD sensor. The image sensing element 104 converts the light received through the lens 103 to an electric signal. Reference numeral 105 denotes an image transmission unit that transmits the electric signal generated by the image sensing element 104 to the range image generation unit 102 as the image data.

Next, an internal configuration of the range image generation unit 102 is described. Reference numeral 106 denotes an image reception unit that receives the image data transmitted from the image capturing unit 101. Reference numeral 107 denotes an image correction unit that performs necessary correction processes on the image data received by the image reception unit 106 as preprocessing of generation of the range image. The correction processes performed in this case do not include the distortion correction of correcting the distortion in the image data caused by the optical system of the image capturing unit 101. Reference numeral 108 is a parallax calculation unit that calculates parallax for each pixel in a post-correction image corrected by the image correction unit 107. Reference numeral 109 denotes a distance calculation unit that converts parallax data calculated by the parallax calculation unit 108 to the range image. Reference numeral 110 denotes a DRAM. In the embodiment, the DRAM 110 stores the range image generated by the distance calculation unit 109. The range image generated by the distance calculation unit 109 and stored in the DRAM 110 in this case is a pre-distortion correction range image in this embodiment. Moreover, information (hereinafter, referred to as coordinate conversion map information) on coordinate values in a pre-correction image that correspond to pixels in a post-correction image in the distortion correction is assumed to be stored in advance in the DRAM 110. Reference numeral 111 denotes a reliability calculation unit that calculates reliability for each set of any number of pixels in the post-correction image corrected by the image correction unit 107. Although the reliability calculation unit 111 is configured to obtain the image data via the DRAM 110 in FIG. 1, the configuration may be such that the reliability calculation unit 111 directly obtains the image data from the image correction unit 107 without obtaining it via the DRAM 110. Reference numeral 112 denotes a static random access memory (SRAM). In the embodiment, the SRAM 112 stores reliability calculated for each pixel. The reliability may be calculated for each set of multiple pixels instead of each pixel and the storage destination of the reliability does not have to be the SRAM and may be other memories. Reference numeral 113 denotes a memory access process content selection unit. In the embodiment, the memory access process content selection unit 113 selects one of distortion correction methods based on the reliability calculated by the reliability calculation unit 111 and preset memory access bandwidths required in the respective distortion correction methods. In the embodiment, the distortion correction method is selected based on the DRAM bandwidth. Reference numeral 114 denotes a distortion correction necessary-unnecessary determination unit that determines whether the distortion correction is to be performed depending on the reliability of the pixel in the pre-correction image corresponding to each pixel in the post-distortion correction image. In this case, the distortion correction necessary-unnecessary determination unit 114 refers to the coordinate conversion map stored in advance in the DRAM 110 and obtains the coordinate values of the pixel in the pre-correction image corresponding to each pixel in the post-distortion correction image. Reference numeral 115 is a distortion correction unit that performs the distortion correction on the pixels for which the distortion correction necessary-unnecessary determination unit 114 has determined that the distortion correction is necessary, in the method selected by the memory access process content selection unit 113 and outputs corrected pixel values. Reference numeral 116 denotes a masking unit that sets predetermined values for the pixels in the post-distortion correction image for which the distortion correction necessary-unnecessary determination unit 114 has determined that the distortion correction is unnecessary and outputs the predetermined values.

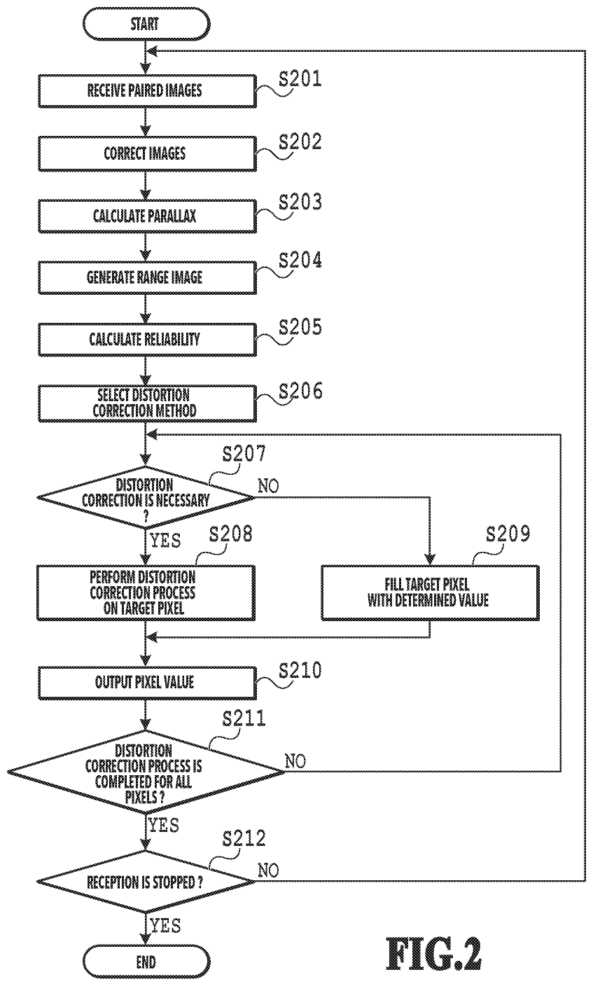

Next, detailed description of the units is given based on a flowchart. FIG. 2 is a flowchart illustrating a process flow of the range image generation unit 102 in the distance measuring apparatus 100 of the embodiment. Note that the range image generation unit 102 can be implemented by an information processing apparatus and the configurations other than the DRAM 110 and the SRAM 112 can be implemented by causing one or more processors to execute a program. This applies also to range image generation units in the other embodiments to be described later.

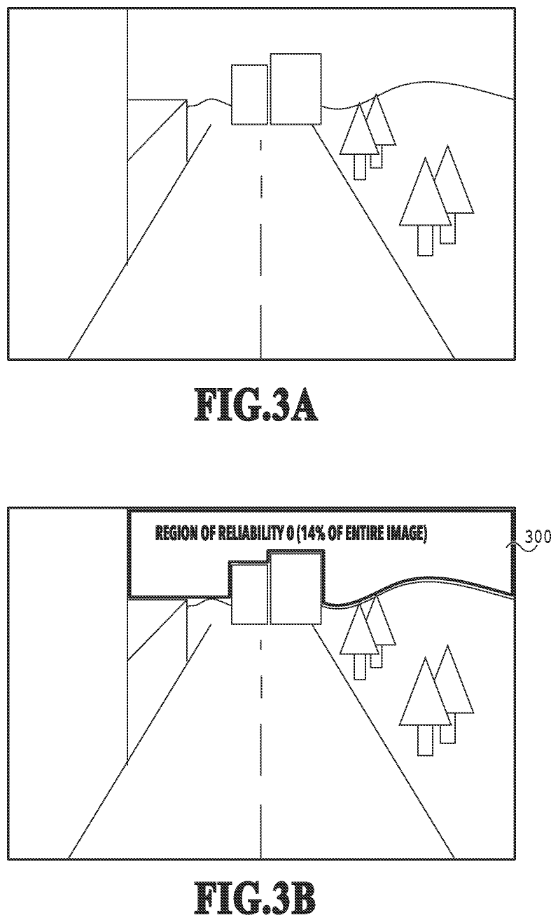

In S201, the image reception unit 106 receives the image data from the image capturing unit 101. In the embodiment, the image reception unit 106 is assumed to receive an image as illustrated in FIG. 3A.

In S202, the image correction unit 107 performs the necessary correction processes other than the distortion correction on the received image. Examples of the correction processes include a scratch correction performed in the case where there is a scratch on the sensor, a shading correction that corrects brightness unevenness occurring due to a reduction of brightness in a direction away from the center of the lens, and the like. Note that the correction performed in this case is not limited to those described above.

In S203, the parallax calculation unit 108 calculates parallax for each pixel in the image corrected in S202. Here, a parallax calculation method called template matching is described. Assume that the image capturing unit 101 includes the image sensing element 104 having multiple photodiodes in one pixel and one of captured images (A image and B image) obtained from the multiple photodiodes in one pixel is set as a template image while the other image is set as a reference image. Then, the parallax calculation unit 108 sets a region of an arbitrary size (hereinafter, referred to as matching region) centered at a point of interest in the template image and determines a region in the reference image with the highest similarity to the matching region by moving an image of the matching region in the reference image step by step. The parallax calculation unit 108 calculates a distance between the point of interest in the matching region in the template image and a center point of the region in the reference image with the highest similarity to the matching region as parallax. In this case, the size of the matching region and the number of moving steps (unit movement amount) of the matching region in the reference image can be set to any values. Moreover, any method can be employed as the method of obtaining the similarity between the images. For example, sum of squared difference (SSD) in which the similarity is evaluated by using a sum of squares of differences between pixel values, sum of absolute difference (SAD) in which the similarity is evaluated by using a sum of absolute values of differences between pixel values, or the like can be used.

In S204, the distance calculation unit 109 calculates the distance for each pixel based on the parallax calculated in S203. The distance calculation unit 109 calculates the distance from the parallax by using the principle of triangulation and generates the pre-distortion correction range image.

In S205, the reliability calculation unit 111 calculates the reliability for each of predetermined pixels in the image corrected in S202. Although the reliability is calculated for each pixel in the embodiment, the reliability may be calculated for each set of any number of pixels. Moreover, although the reliability is calculated in one bit in the embodiment, the reliability may be calculated in any number of bits. The reliability is calculated based on factors that affect the distance measuring accuracy. In the calculation of distance using the phase difference method in the embodiment, the reliability is calculated based on an amount of variation in contrast. The amount of variation in contrast can be calculated from dispersion of pixel values of the point of interest and pixels around the point of interest. In the embodiment, a reliability calculation algorithm is assumed to be adjusted such that the reliability of a region 300 (region corresponding to the sky) in FIG. 3B is calculated to be 0 and the reliability of the other regions is calculated to be 1 for the input image of FIG. 3A. In this case, a threshold is set to 1, and 0 being less than the threshold means low reliability while 1 being equal to or greater than the threshold means high reliability.

Moreover, although the calculated reliability is stored in the SRAM in association with the coordinate values to allow reading at high speed in the embodiment, the reliability may be stored in other memories. Moreover, the region 300 with reliability of 0 occupies about 14% of the entire image region in the embodiment.

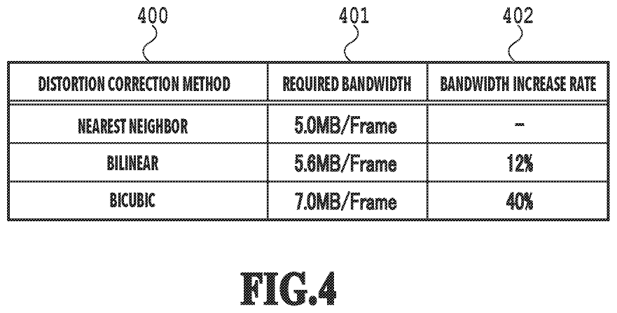

In S206, the memory access process content selection unit 113 selects one of the distortion correction methods based on the reliability calculated in S204 and the preset DRAM bandwidths required for the respective distortion correction methods. In the embodiment, the distortion correction method is selected from three distortion correction methods of nearest neighbor, bilinear, and bicubic, depending on the proportion of a region with low reliability. Note that the types of distortion correction methods are not limited to those described above. Moreover, a method of providing information on the DRAM bandwidths required for the respective distortion correction methods may be any method. For example, an input unit for a user may be prepared or the information may be stored in advance in memories such as the DRAM and the SRAM. In the embodiment, the bandwidth information as in the table illustrated in FIG. 4 is provided. However, this format is merely an example and any format can be used as long as the bandwidths required for the respective distortion correction methods can be recognized. The column 400 in the table illustrated in FIG. 4 describes the types of the distortion correction methods.

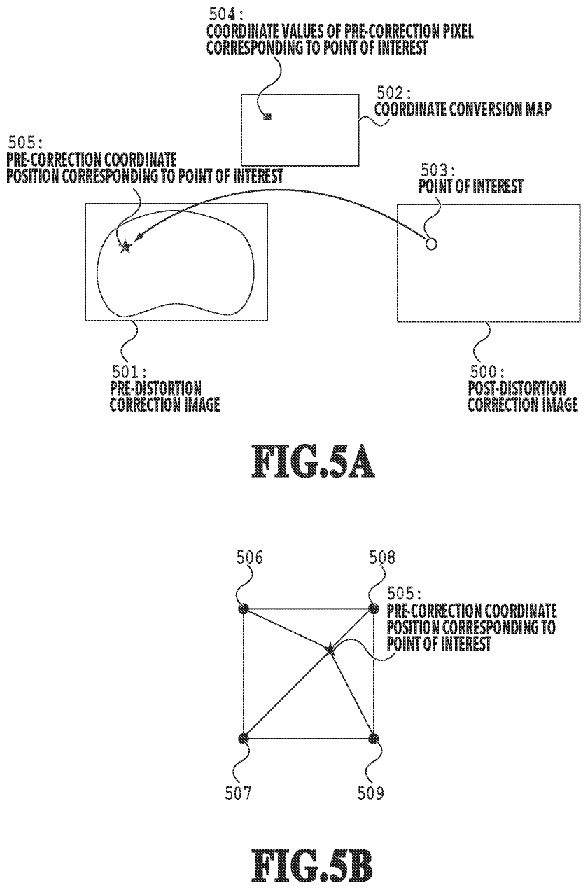

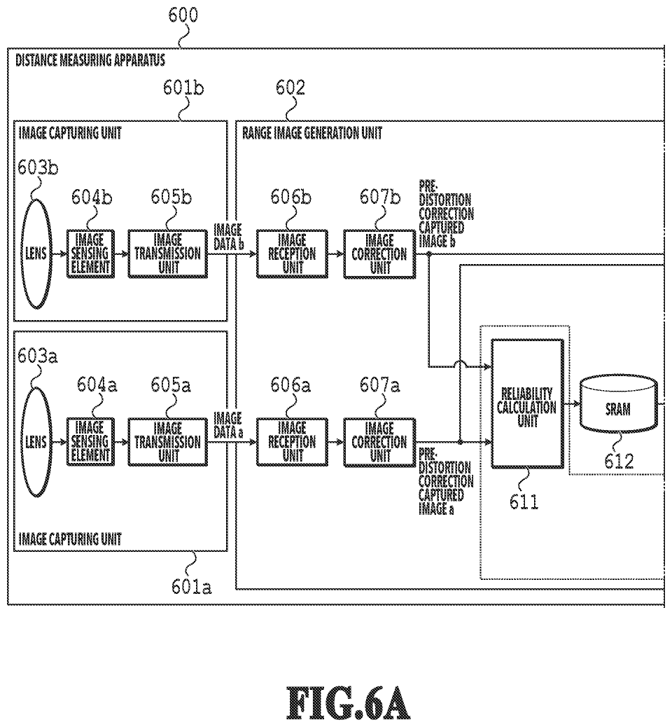

Description is given of the three distortion correction methods of nearest neighbor, bilinear, and bicubic. FIG. 5A is a diagram explaining the distortion correction.

Reference numeral 500 denotes the post-distortion correction image and a pixel of a point of interest 503 is assumed to be currently corrected. First, coordinate values 504 (hereinafter, referred to as pre-correction coordinate values) of a pixel in a pre-correction image corresponding to the point of interest 503 are referred to. Although the pre-correction coordinate values 504 are obtained by referring to values corresponding to post-correction coordinate values among the values stored in advance in the DRAM 110 as a coordinate conversion map 502 in the embodiment, the pre-correction coordinate values 504 may be stored in memories other than the DRAM 110. Although the coordinate conversion map 502 is a map calculated in advance based on a coordinate conversion formula according to distortion aberration of the lens 103, the method of obtaining the pre-correction coordinate values 504 is not limited to the method described above. The method of obtaining the pre-correction coordinate values 504 may be a method in which the pre-correction coordinate values 504 are calculated one by one in the distance measuring apparatus 100 by using the aforementioned coordinate conversion formula.

Reference numeral 501 denotes the pre-correction image and reference numeral 505 denotes a coordinate position (hereinafter, referred to as pre-correction coordinate position) of the pre-correction coordinate values 504 corresponding to the point of interest 503. The pre-correction coordinate values 504 obtained by using the coordinate conversion formula generally include decimals. Accordingly, in the nearest neighbor, as in FIG. 5B, a pixel value of a pixel 508 that is a pixel located closest to the pre-correction coordinate position 505 in the pre-correction image 501 is set as a post-correction pixel value of the point of interest 503. Meanwhile, in the bilinear, a value obtained by interpolation using pixel values of four pixels 506, 507, 508, and 509 around the pre-correction coordinate position 505 in the pre-correction image 501 is set as the post-correction pixel value of the point of interest 503. Moreover, in the bicubic, a value obtained by interpolation using pixel values of 16 pixels around the pre-correction coordinate position 505 in the pre-correction image 501 is set as the post-correction pixel value of the point of interest 503. Accordingly, only one pixel value needs to be read from the DRAM 110 in the nearest neighbor, four pixel values need to read in the bilinear, 16 pixel values need to be read in the bicubic, and the DRAM bandwidth increases depending on the type of the distortion correction method. Meanwhile, the accuracy of the distortion correction in the bilinear is higher than that in the nearest neighbor and the accuracy in the bicubic is higher than that in the bilinear.

Next, the column 401 of FIG. 4 describes examples of the bandwidths of the DRAM 110 required for the respective distortion correction methods. As described above, since four times as much pixel values as the pixel value in the nearest neighbor need to be read in the bilinear and 16 times as much pixel values as the pixel value in the nearest neighbor need to be read in the bicubic, the required bandwidths are also four times and 16 times as much as that in the nearest neighbor in the cases where all pixel values are read from the DRAM 110 in every operation. However, for example, some of the four pixel values in the pre-correction image 501 used in the distortion correction of a certain pixel in the bilinear are highly likely to be referred to in the distortion correction of the adjacent pixel. Accordingly, a cache is generally provided for the DRAM 110 and the pixel values once read from the DRAM 110 are temporarily stored in the cache for a predetermined period. This can reduce the DRAM bandwidth by reading the pixel values from the cache without accessing the DRAM 110 in the case where the pixel values of the same pixels are read again in a certain period. How much the bandwidth can be reduced varies depending on the hit rate of the cache. In the embodiment, the DRAM 110 is assumed to be accessed in a unit of tile (unit of a region formed of certain numbers of pixels in the vertical and horizontal directions) and a cache hit rate is estimated from the distortion aberration of the lens and the region of pixels referred to in each distortion correction method. The required bandwidth 401 of the DRAM 110 illustrated in FIG. 4 describes examples of values calculated based on such estimation.

The column 402 describes bandwidth increase rates of the respective distortion correction methods with the nearest neighbor being the reference. Referring to the column 402, the bandwidth increase rate of the bilinear is 12% and the bandwidth increase rate of the bicubic is 40%. The memory access process content selection unit 113 first refers to the reliability calculated in S204 and obtains the proportion of the region with reliability of 0 to the entire image. Assume that 14% is obtained in this case. As described in detail later, the region with the reliability of 0 is determined as pixels for which the distortion correction is unnecessary in the later step. Accordingly, the case where the region with the reliability of 0 is 14% means that the number of pixels for which the distortion correction is performed can be reduced by 14% and, with this reduction, the bandwidth required for the reading the pixel values from the DRAM 110 can be reduced by 14%. Specifically, in the case where the proportion of the region with the reliability of 0 is 14%, the bandwidths required for the nearest neighbor, the bilinear, and the bicubic are 4.3 MB/frame, 4.8 MB/frame, and 6.0 MB/frame, respectively.

Next, the memory access process content selection unit 113 refers to the bandwidth increase rates of the respective distortion correction methods in FIG. 4 and determines which distortion correction method is applicable by using the reducible bandwidth. In the embodiment, the required bandwidth of 5.0 MB/frame for the nearest neighbor in the case where the distortion correction is performed on the entire region is set as the maximum allowable bandwidth and the distortion correction method whose required bandwidth is equal to or lower than the maximum allowable bandwidth (equal to lower than the highest access bandwidth that is allowed) is employed. In the case where the bandwidth reduction rate is 14% as described above, the required bandwidth for the bilinear is 4.8 MB/frame and the required bandwidth for the bicubic is 6.0 MB/frame. Accordingly, the bilinear distortion correction method is selected which is the distortion correction method with the highest accuracy among the distortion correction methods with the required bandwidth of 5.0 MB/frame or less. For example, in the case where the bandwidth reduction ratio is less than 10%, the required bandwidth for the bilinear is higher than 5.0 MB/frame. Accordingly, the nearest neighbor distortion correction method is selected. Meanwhile, in the case where the bandwidth reduction ratio is equal to or higher than 28%, the required bandwidth for the bicubic is 5.0 MB/frame or less. Accordingly, the bicubic distortion correction method is selected.

In the embodiment, one of the distortion correction methods is thus selected based on the predetermined maximum allowable bandwidth and the DRAM bandwidths required for the respective distortion correction methods in the region excluding the region with low reliability as described above.

In S207, the distortion correction necessary-unnecessary determination unit 114 determines whether the distortion correction needs to performed, for each of the pixels in the range image generated in S204. In S207, as in the calculation of the reliability described above, the distortion correction necessary-unnecessary determination unit 114 reads the pre-correction coordinate values 504 corresponding to a pixel of interest in the post-correction image, from the DRAM 110. Then, the distortion correction necessary-unnecessary determination unit 114 reads the reliability of the pixel closest to the pre-correction coordinate position 505 corresponding to the read pixel of interest, from the SRAM 112. Next, if the reliability is 0, the distortion correction necessary-unnecessary determination unit 114 determines that the distortion correction is unnecessary and the processing proceeds to S209. Meanwhile, if the reliability is 1, the distortion correction necessary-unnecessary determination unit 114 determines that the distortion correction is necessary and the processing proceeds to S208.

Next, in S208, the distortion correction unit 115 performs the distortion correction on the pixel of interest for which the distortion correction is determined to be necessary in S207, in the distortion correction method selected in S206. Since the bilinear distortion correction method is selected in the embodiment, the bilinear distortion correction is performed. In this case, the distortion correction unit 115 receives the pre-correction coordinate values 504 read by the distortion correction necessary-unnecessary determination unit 114 from the DRAM 110 and thus does not have to read the pre-correction coordinate values 504 from the DRAM 110.

Meanwhile, in S209, the masking unit 116 assigns a predetermined value to the pixel for which the distortion correction is determined to be unnecessary in S207, without performing the distortion correction. Since no distortion correction is performed on the pixel for which the distortion correction is determined to be unnecessary, the process of reading the pre-correction pixel value from the DRAM 110 for the distortion correction is unnecessary and the DRAM bandwidth can be reduced. Moreover, a DRAM bandwidth corresponding to reduction from the allowable DRAM bandwidth, in the case of the embodiment, 5.0 MB/frame can be used for the distortion correction in S208.

Next, in S210, the distortion correction unit 115 or the masking unit 116 outputs the pixel value subjected to the distortion correction or the pixel value masked by using the predetermined value. Although the configuration is such that the distortion correction unit 115 and the masking unit 116 output the pixel value subjected to the distortion correction and the masked pixel value to the outside of the distance measuring apparatus 100 in the embodiment, a mode in which the pixel values are stored in a memory inside the distance measuring apparatus 100, for example, the DRAM 110 may be employed.

As described above, the pixel value of one pixel in the range image can be generated and outputted in the processing from S207 to S210.

In S211, whether any one of the distortion correction and the masking is performed for all pixels in the range image is determined. If there is an unprocessed pixel, the processing returns to S207. The post-distortion correction range image can be outputted by repeatedly performing such steps for all pixels.

Next, in S212, if the reception of the image is not stopped based on, for example, a user input, the processing returns to S201 and the next image is received. The aforementioned processing is constantly executed until the image reception is stopped.

In the case where two captured images are obtained from one optical system as described above, the embodiment is preferably applied in a configuration in which the range image is first generated from the two captured images and then subjected to the distortion correction. In this case, the distortion correction is performed only on one range image instead of two captured images and the number of pixel values read for the distortion correction is reduced to half. Accordingly, the DRAM bandwidth can be reduced. In addition, since no distortion correction process is performed for the region with low reliability, the DRAM bandwidth can be further reduced. As a result, the distortion correction method for the region to be subjected to the distortion correction can be selected depending on the bandwidth reduction amount. The reduced bandwidth can be thereby allocated to the distortion correction for the region to be subjected to the distortion correction and distortion correction with higher accuracy can be achieved.

Moreover, although the reliability is expressed by two values of 0 and 1 in the embodiment, the reliability may be expressed by three or more values. For example, in the case where the reliability is expressed by three values of 0, 1, and 2, the configuration may be such that the distortion correction is not performed for the reliability of 0 and the distortion correction is performed for the reliabilities of 1 and 2 in different distortion correction methods, respectively.

### Embodiment 2

In Embodiment 1, the range image is generated before the distortion correction and the distortion correction is then performed on the range image. However, in Embodiment 2, the distortion correction is performed before the generation of the range image and the range image is then generated. In Embodiment 2, description is given of a distance measuring apparatus using a stereo camera as the image capturing device. In the case where captured images are obtained by using multiple separate optical systems arranged several centimeters to ten-odd centimeters apart as in a stereo camera, the distortion amount of the captured image varies between the optical systems. Accordingly, a configuration in which the distortion correction is performed on the multiple captured images and then the range image is generated is preferable. An error in parallax increases in the case where the parallax is calculated by using captured images with different distortion amounts. Accordingly, a highly-accurate range image can be obtained by first performing the distortion correction on the captured images and then calculating the parallax to generate the range image.

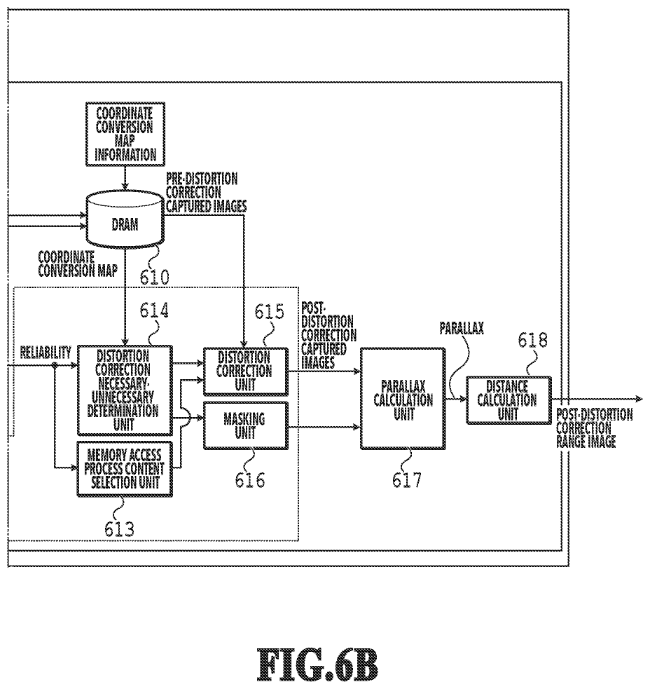

FIGS. 6A and 6B are a configuration diagram of a distance measuring apparatus of Embodiment 2. Reference numeral 600 denotes the distance measuring apparatus of the embodiment that generates a range image of a subject. The distance measuring apparatus 600 includes two image capturing units 601a and 601b and a range image generation unit 602. Note that, since processing of the image capturing units 601a and 601b is the same as that of the image capturing unit 101 in Embodiment 1, detailed description thereof is omitted.

The range image generation unit 602 receives paired captured images formed of image data a and image data b with certain parallax, from the two image capturing units. The received pieces of captured image data are received by two image reception units 606a and 606b and then subjected to various types of image correction including no distortion correction in two image correction units 607a and 607b, respectively. Since processing of the image reception units 606a and 606b and the image correction units 607a and 607b is the same that in Embodiment 1, detailed description thereof is omitted.

The two image correction units 607a and 607b provide a pre-distortion correction captured image a and a pre-distortion correction captured image b and these pre-distortion correction captured images are sent to a DRAM 610 and a reliability calculation unit 611. The two pre-distortion correction captured images a and b sent to the DRAM 610 are referred to in the distortion correction. Moreover, coordinate conversion map information in the distortion correction is assumed to be stored in advance in the DRAM 610. In this case, since the distortion amounts of the respective captured images obtained by the two image capturing units are different from each other, two coordinate conversion maps corresponding to the distortion amounts of the respective captured images are stored.

Meanwhile, the reliability calculation unit 611 calculates the reliability of each of the received two pre-distortion correction captured images. Note that, since the reliability calculation unit 611 is the same as the reliability calculation unit 111 in Embodiment 1, detailed description thereof is omitted. Pieces of calculated reliability data are stored in an SRAM 612.

Hereinafter, processes of a memory access process content selection unit 613, a distortion correction necessary-unnecessary determination unit 614, a distortion correction unit 615, and a masking unit 616 are performed on the two captured images. Since the processes of these units on the captured images are the same as the processes of the memory access process content selection unit 113, the distortion correction necessary-unnecessary determination unit 114, the distortion correction unit 115, and the masking unit 116 in Embodiment 1, detailed description thereof is omitted.

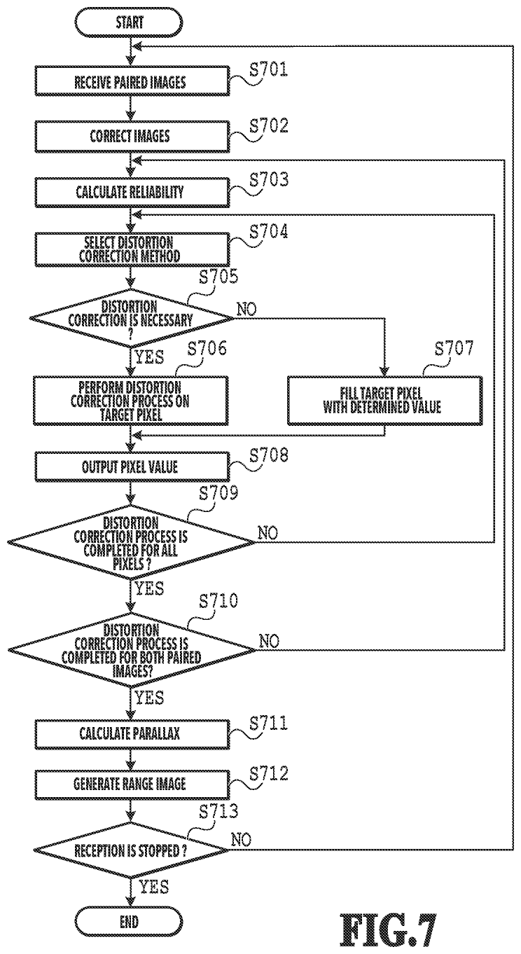

Next, detailed description of the units is given based on a flowchart. FIG. 7 is a flowchart illustrating a process flow of the range image generation unit 602 in the distance measuring apparatus 600 of the embodiment.

In steps other than S710, the same processes as the corresponding steps in the flowchart of FIG. 2 are performed even though the order of the steps is different from that in the flowchart of FIG. 2. S701 and S702 correspond to S201 and S202, S703 to S709 correspond to S205 to S211, S711 and S712 correspond to S203 and S204, and S713 corresponds to S212. In the embodiment, S710 is added to perform the distortion correction on the pre-distortion correction captured image a and the pre-distortion correction captured image b.

In these processes, no distortion correction is performed for a region with low reliability as in Embodiment 1 and this can reduce the pixel values to be read and reduce the DRAM bandwidth. Highly-accurate distortion correction can be thus performed in a limited maximum allowable bandwidth.

As described above, the captured images obtained from the two image capturing units are subjected to the distortion correction and two post-distortion correction images are obtained. A parallax calculation unit 617 obtains parallax from these post-distortion correction images and a distance calculation unit 618 further obtains the range image. Since process contents of the parallax calculation unit 617 and the distance calculation unit 618 are the same as those of the parallax calculation unit 108 and the distance calculation unit 109 in Embodiment 1, detailed description thereof is omitted.

In a distance measuring apparatus that generates a range image by obtaining multiple captured images with multiple separate optical system as in a stereo camera as described above, the distortion amount of the captured image varies between the optical systems. Accordingly, the distortion correction is preferably performed before the generation of the range image as in the embodiment. This enables calculation of parallax between captured images correctly subjected to the distortion correction and a highly-accurate range image can be obtained. Moreover, performing no distortion correction for the region with low reliability enables reduction of the DRAM bandwidth and the distortion correction method to be applied to the region to be subjected to the distortion correction can be selected depending on the bandwidth reduction amount. The reduced bandwidth can be thereby allocated to the distortion correction for the region to be subjected to the distortion correction and the distortion correction with higher accuracy can be achieved.

### Embodiment 3

Although the reliability is calculated for each pixel in Embodiment 1, one piece of reliability is generated for each set of multiple pixels depending on a cache size in Embodiment 3. This can increase the hit rate of the cache and reduce the DRAM bandwidth. Moreover, the size of the SRAM storing the reliability can be reduced. Embodiment 3 is assumed to employ the method in which multiple photodiodes are arranged for one distance measuring pixel and a distance is calculated by using the phase difference method, as in Embodiment 1. Accordingly, the distance measuring apparatus is configured to generate the range image and then perform the distortion correction. Note that one piece of reliability can be generated for each set of multiple pixels depending on the cache size also in the configuration in which the distance measuring apparatus performs the distortion correction and then generates the range image as in Embodiment 2.

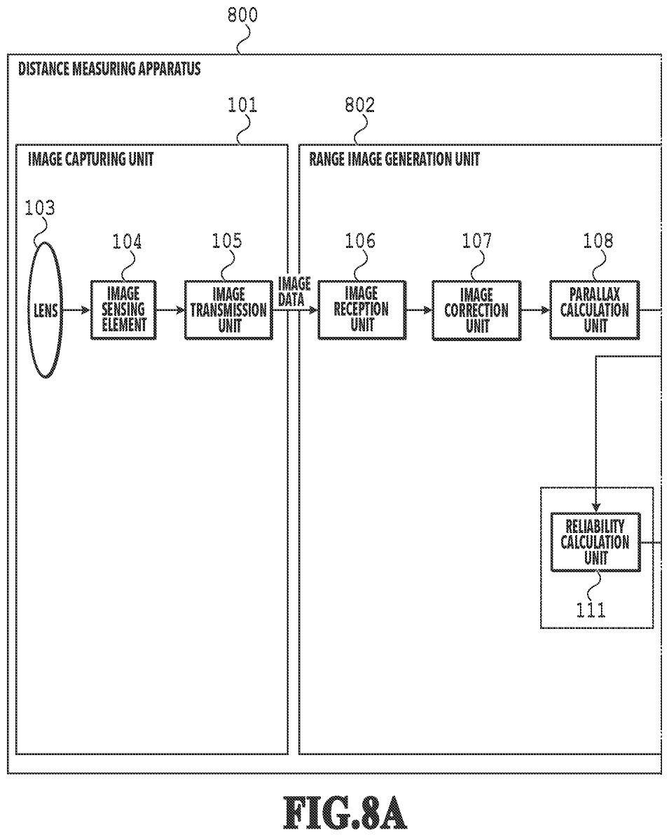

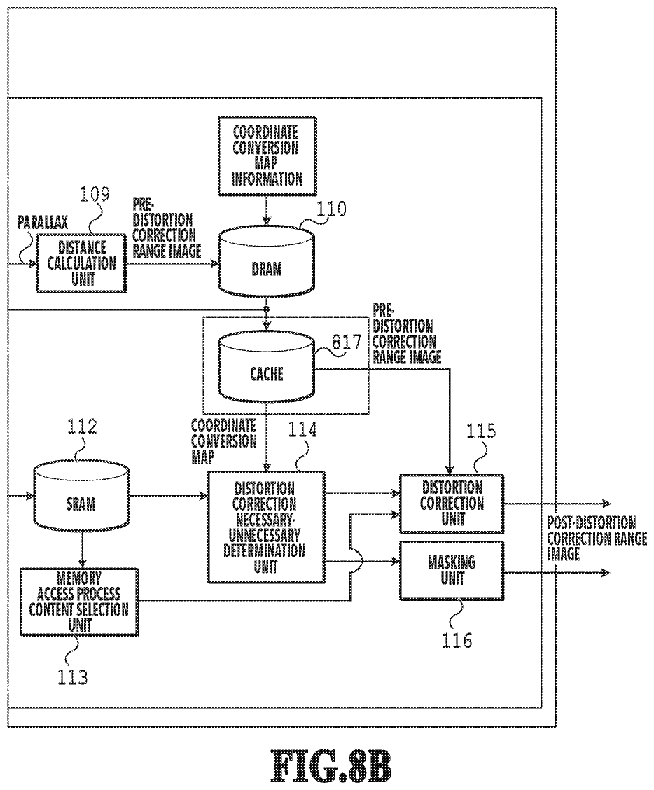

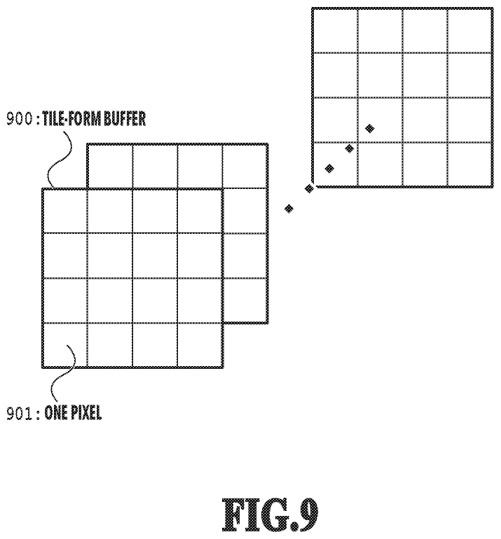

FIGS. 8A and 8B are a configuration diagram of Embodiment 3. In this configuration diagram, a cache 817 is added to the configuration of FIG. 1. A structural example of the cache 817 is described by using FIG. 9. The cache 817 is configured to have multiple tile-form buffers 900 (hereinafter, referred to as tile buffers). Moreover, one tile buffer can hold data for total of 16 pixels (four pixels by four pixels in the vertical and horizontal directions) and replacement of the cache is performed in a unit of buffer tile. Reference numeral 901 denotes one pixel. Note that the size of four pixels by four pixels in the vertical and horizontal directions is an example and the size in the vertical and horizontal directions and the number of tile buffers can be set to any size and number.

Next, a process flow in the embodiment is described by using the flowchart of FIG. 2.

Since S201 to S204 are the same as those in Embodiment 1, detailed description thereof is omitted.

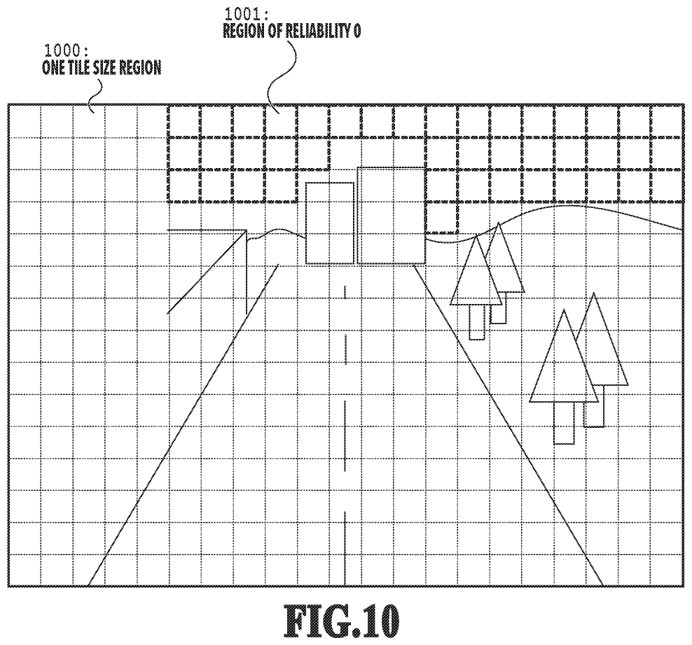

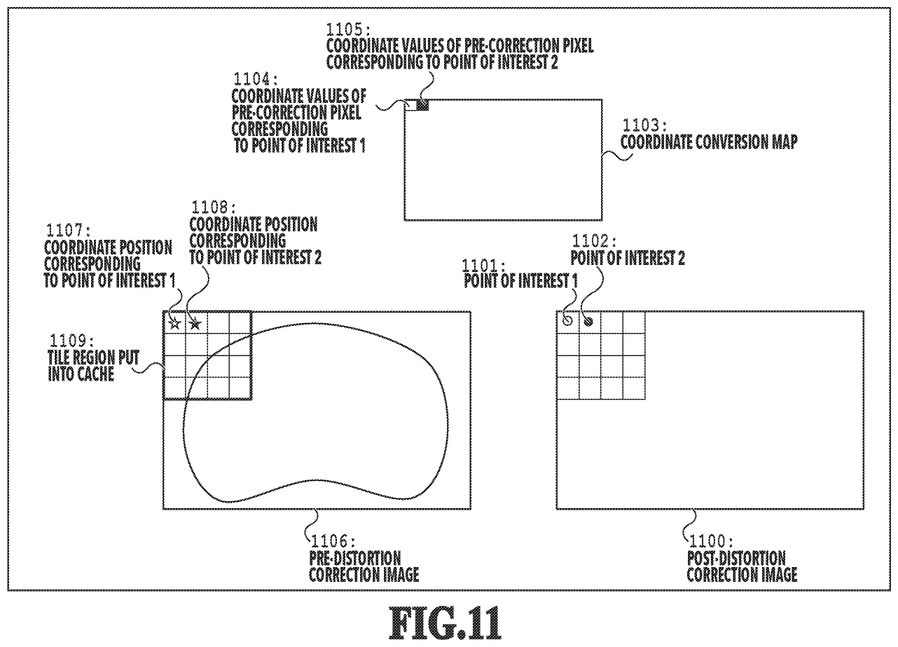

Next, in S205, the reliability calculation unit 111 calculates the reliability of each of regions with a pixel size of one tile buffer (hereinafter, referred to as tile buffer size) in the cache 817. In the embodiment, one piece of reliability is calculated for a region of four pixels by four pixels in the vertical and horizontal directions. There are various methods of calculating the reliability of each tile buffer size region. In the embodiment, the reliability of each pixel in the tile buffer size region is calculated once and then, if there is at least one pixel with reliability of 1 in the tile buffer size region, the reliability of this region is set to 1. An image illustrating the reliability generated in the case where the input image is FIG. 3A is illustrated in FIG. 10. Each of small square regions 1000 in FIG. 10 is one tile buffer size region and one piece of reliability is generated for each of these regions. Regions surrounded by bold lines like regions 1001 in the embodiment are the regions with reliability of 0. In this case, calculating the reliability per tile buffer size reduces the data amount of reliability, and the size of SRAM required to store the reliability can be reduced.

Since S206 is the same as that in Embodiment 1, detailed description thereof is omitted.

Next, S207 to S209 are collectively described by using FIG. 11. Reference numeral 1100 denotes a post-distortion correction image and the distortion correction of a point of interest 1 (1101) is first performed. Pre-correction coordinate values 1104 corresponding to the point of interest 1 is read from a coordinate conversion map 1103. Then, the reliability of the tile buffer size region corresponding to the pre-correction coordinate values 1104 is read. In this example, the reliability is assumed to be 1. In the case where the nearest neighbor is selected as the distortion correction method, a pixel value of a pixel closest to a pre-distortion correction coordinate position 1107 corresponding to the pre-correction coordinate values 1104 in a pre-distortion correction image 1106 is attempted to be read from the DRAM 110. In the case where this pixel value is not held in the cache 817, data of a tile buffer size region 1109 including this pixel value is stored in a tile buffer of the cache 817 and the necessary pixel value is read from the tile buffer of the cache 817.

Next, the distortion correction for a point of interest 2 (1102) is performed. In this case, reliability of a tile buffer size region corresponding to pre-correction coordinate values 1105 for the point of interest 2 is read. However, since the point of interest 2 is adjacent to the point of interest 1, the tile buffer size region for the point of interest 2 is sometimes the same as that for the point of interest 1. In this example, the tile buffer size region for the point of interest 2 is assumed to be the same as that for the point of interest 1, and the reliability of the same tile buffer size region 1109 as that for the point of interest 1 is read for the point of interest 2 and the reliability of 1 is obtained. Since the reliability is 1, the distortion correction unit 115 attempts to read the pixel value of a pixel closest to a pre-correction coordinate position 1108 corresponding to the pre-correction coordinate values 1105 to perform the distortion correction. In this case, since the distortion correction unit 115 refers to the reliability of the same tile buffer size region 1109 as that for the point of interest 1, the pixel value to be read is also included in the same tile buffer size region 1109 as that for the point of interest 1. Since the tile buffer size region 1109 is already held in the tile buffer of the cache 817, the distortion correction unit 115 can read the pixel value from the cache 817 without accessing the DRAM 110 (achieve a cache hit).

The case where the distortion correction method is the nearest neighbor is described above. Also in the bilinear and the bicubic, since the pixel values of pixels near the pre-correction coordinate position are collectively read into the cache 817, the possibility of cache hit is similarly high. Generating the reliability for each tile buffer region of the cache as described above can increase the cache hit rate and allows efficient reading of data in the DRAM. Moreover, calculating the reliability per tile buffer size can reduce the data amount of reliability and reduce the SRAM size required to store the reliability.

Although the reliability calculation unit 111 is configured to obtain the image data via the DRAM 110 in FIG. 8, the reliability calculation unit 1 may be configured to directly obtain the image data from the image correction unit 107 without obtaining it via the DRAM 110.

### Embodiment 4

In Embodiments 1 to 3, no distortion correction is performed for the pixels with reliability of 0 to reduce the DRAM bandwidth relating to the distortion correction and allow the reduced bandwidth to be used in the distortion correction for the pixels with high reliability. In Embodiment 4, description is given of an example in which additional processes for increasing an additional value of a distance measuring apparatus are performed by using the reduced bandwidth.

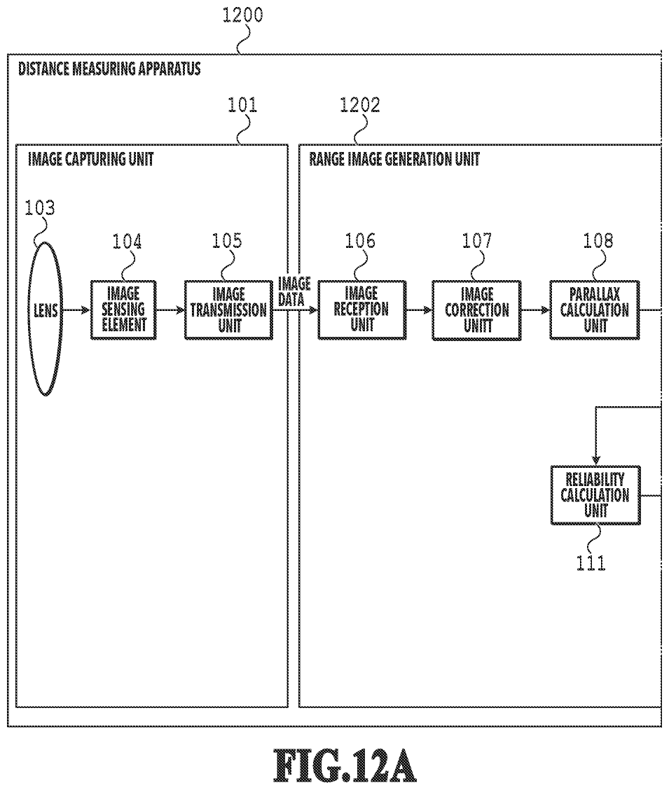

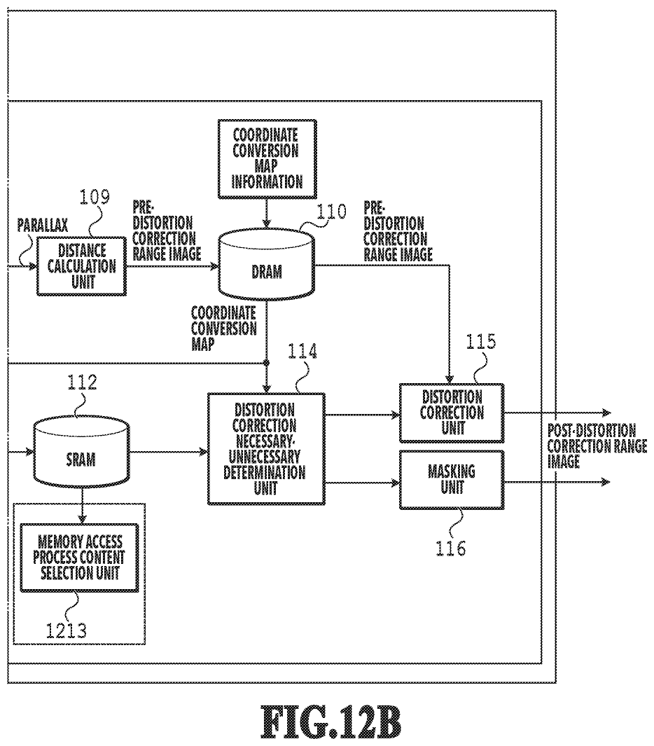

FIGS. 12A and 12B are a configuration diagram of a distance measuring apparatus of Embodiment 4. In FIG. 1 (Embodiment 1), the memory access process content selection unit 113 selects the distortion correction method and thus sends the selection result to the distortion correction unit 115. Meanwhile, in FIG. 12 (Embodiment 4), a memory access process content selection unit 1213 selects one of additional processes different from the distortion correction and thus does not have to be connected to the distortion correction unit 115. An additional process to be executed is selected depending on the DRAM bandwidth required for the distortion correction set in advance, the DRAM bandwidths required for the additional processes to be selected by the memory access process content selection unit 1213, and the proportion of the region with reliability of 0.

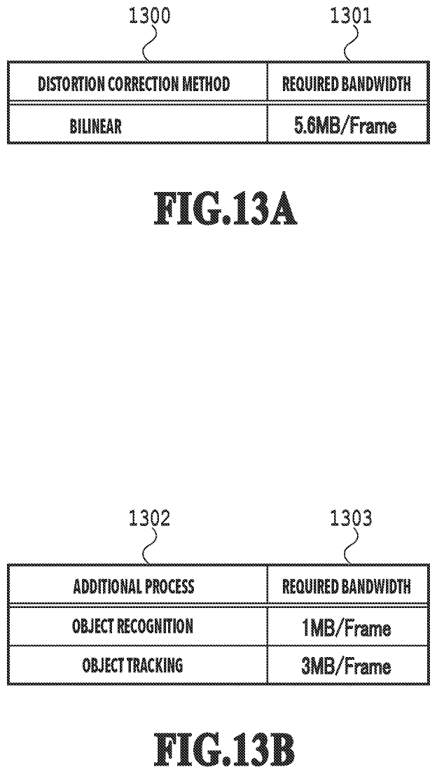

FIG. 13A is information on a bandwidth required for the used distortion correction method. Although the bilinear distortion correction method is assumed to be used in the embodiment, other distortion correction methods may be used. Next, the proportion of the region with reliability of 0 stored in the SRAM is calculated. In this case, 23% of the image is assumed to be the region with the reliability of 0. Then, it is possible to reduce 23% of 5.6 MB/frame that is the DRAM bandwidth (1301) required for the bilinear distortion correction, specifically, a bandwidth of 1.3 MB/frame.

Next, FIG. 13B illustrates information on the additional processes to be selected by the memory access process content selection unit 1213. In this example, two types of processes of an object recognition process and an object tracking process are described as the additional processes 1302. DRAM bandwidths 1303 required for the object recognition process and the object tracking process are 1 MB/frame and 3 MB/frame, respectively.

Next, the additional processes executable by using a reducible bandwidth is selected. Since the bandwidth of 1.3 MB/frame is reducible in the embodiment, only the object recognition process is selected. In the case where the bandwidth reduction of 4 MB/frame or more is possible, the object recognition process and the object tracking process are both selected.

Although there are only two types of additional processes that are candidates of selection in this embodiment, there may be three or more types. Moreover, an algorithm that determines the additional process to be selected may be any method. Furthermore, a method of providing the information on the DRAM bandwidths required for the distortion correction method and the additional processes may be any method. For example, an input unit for a user may be prepared to receive this information from a user input or the information may be stored in advance in memories such as the DRAM and the SRAM. Although the bandwidth information is provided in the formats illustrated in FIGS. 13A and 13B in the embodiment, these formats are merely examples and different formats can be used.

The object recognition process selected depending on the bandwidth reduction amount is thus executed. Combining a result of the object recognition and the generated range image allows a certain target object (human, animal, vehicle, or the like) and information on the distance to this target object to be associated with each other. Moreover, handling the obtained distance information and the recognition result in multiple frames in time series enables calculation of speed and a trajectory of the target object.

As described above, performing no distortion correction for the region with low reliability enables reduction of the DRAM bandwidth and the additional process for increasing the additional value of the distance measuring apparatus can be executed by using the reduced bandwidth.

Although the reliability calculation unit 111 is configured to obtain the image data via the DRAM 110 in FIG. 12, the reliability calculation unit 111 may be configured to directly obtain the image data from the image correction unit 107 without obtaining it via the DRAM 110.

### Embodiment 5

In Embodiments 1 to 4 described above, no distortion correction is performed for the pixels with reliability of 0 or the pixels with low reliability in the case where the reliability is expressed by multiple values, and the DRAM bandwidth relating to the distortion correction is thereby reduced.

Meanwhile, in Embodiment 5, control using the reliability is performed also for processes other than the distortion correction that involve access to the DRAM such as scaling of a display region, cut-out of a partial region, multi-screen display performed by specifying multiple regions, to reduce the used DRAM bandwidth.

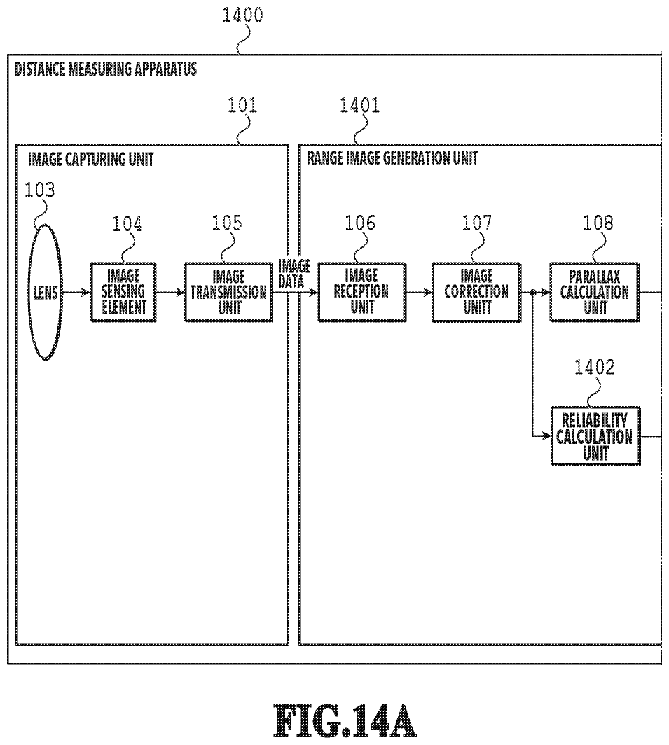

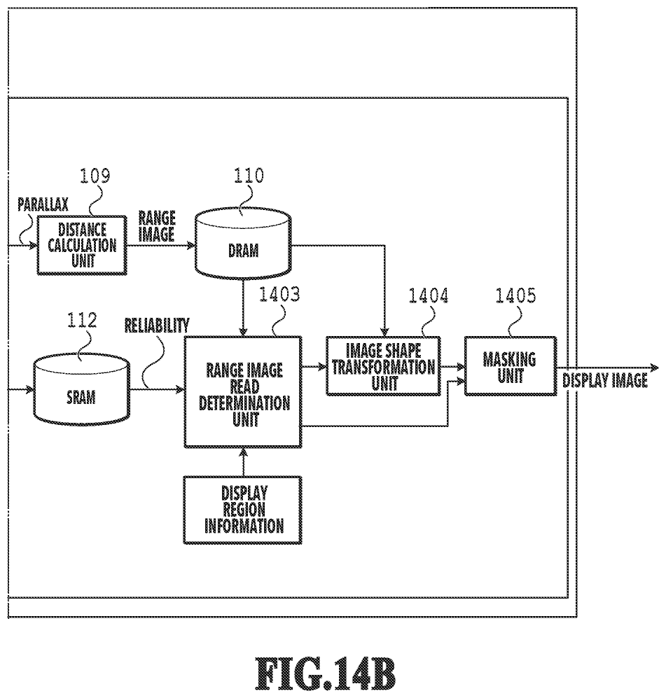

FIGS. 14A and 14B are a diagram illustrating a configuration of a distance measuring apparatus according to Embodiment 5. Functions overlapping those in the aforementioned embodiments are denoted by the same reference numerals.

Reference numeral 140 denotes a distance measuring apparatus according to the embodiment that displays a specified image region and that generates a range image of a subject subjected to the distortion correction. Reference numeral 1401 denotes a range image generation unit that receives the image data from the image capturing unit 101 and generates the range image. The range image generation unit 1401 can output an image (hereinafter, referred to as display image) obtained by subjecting the range image not only to the distortion correction but also to processes such as cut-out, and scaling such that a predetermined image region of the range image is outputted.

An internal configuration of the range image generation unit 1401 is described. The image correction unit 107 performs necessary correction processes on the image data received by the image reception unit 106. For example, the image correction unit 107 performs a process of correcting brightness unevenness caused by a peripheral light amount decrease that occurs in the case where light passes through the lens 103 and a process of correcting characteristic unevenness such as sensitivity unevenness among pixels of the image sensing element 104. Reference numeral 108 denotes a parallax calculation unit that calculates parallax for each of pixels in the post-correction image corrected by the image correction unit 107. Reference numeral 109 denotes a distance calculation unit that converts parallax data calculated by the parallax calculation unit 108 to the range image. Reference numeral 110 denotes a DRAM that stores the range image generated by the distance calculation unit 109.

Reference numeral 1402 is a reliability calculation unit that calculates reliability for each set of any number of pixels in the image from the image correction unit 107. Reference numeral 112 denotes a SRAM that stores the reliability calculated for each pixel in the embodiment. The reliability may be calculated for each set of multiple pixels instead of each pixel. Moreover, the storage destination of the reliability does not have to be the SRAM and may be other memories.

Reference numeral 1403 denotes a range image read determination unit. The range image read determination unit 1403 refers to information (hereinafter, referred to as display region information) on a cut-out position and a degree of scaling of the range image corresponding to the display image and generates coordinate values of the range image corresponding to each of pixels in the display image. Moreover, the range image read determination unit 1403 determines whether to read the range image from the DRAM 110 depending on the display region information and the reliability of each of pixels in the range image. In the case where the distortion correction is to be performed, the range image read determination unit 1403 refers to a coordinate conversion map for associating coordinate values in the pre-distortion correction image and the post-distortion correction image and generates the coordinate values in the pre-distortion correction image corresponding to each of pixels in the post-distortion correction image as in the aforementioned other embodiments.

Reference numeral 1404 denotes an image shape transformation unit that performs an image shape transformation process on a pixel for which the range image read determination unit 1403 determines that the range image needs to be read, and outputs a post-image shape transformation pixel value. In the image shape transformation process, the image shape transformation unit 1404 refers to the coordinate values outputted from the range image read determination unit 1403 and reads a pixel value corresponding to this coordinate values in the range image from the DRAM 110. An interpolation method typified by bilinear and bicubic that use peripheral pixel values may be used as a method of calculating the pixel value. In the case of image cut-out that involves no scaling, the image shape transformation unit 1404 may read the range image as it is according to the coordinate values. Note that the image shape transformation process performed by the image shape transformation unit 1404 includes the distortion correction in addition to the cut-out, the scaling, and the like.

Reference numeral 1405 denotes a masking unit. In the case where the range image read determination unit 1403 determines that reading of the range image is unnecessary, the masking unit sets a predetermined value for a pixel in the display image and outputs this value.

The hardware configuration of the distance measuring apparatus according to Embodiment 5 is thus described by using FIG. 14.

The distance measuring apparatus can be achieved in a similar configuration also in the case where the distortion correction is performed as in the aforementioned embodiments. In this case, the coordinate conversion map for associating the pre-distortion correction coordinates and the post-distortion correction coordinates are stored in advance in the DRAM 110 and the coordinate values of the pixel in the pre-distortion correction image corresponding to each pixel in the post-distortion correction image are generated based on the coordinate conversion map. A process flow in the case of performing the image shape transformation process including the distortion correction by using the coordinate conversion map and the display region information is described below based on a flowchart.

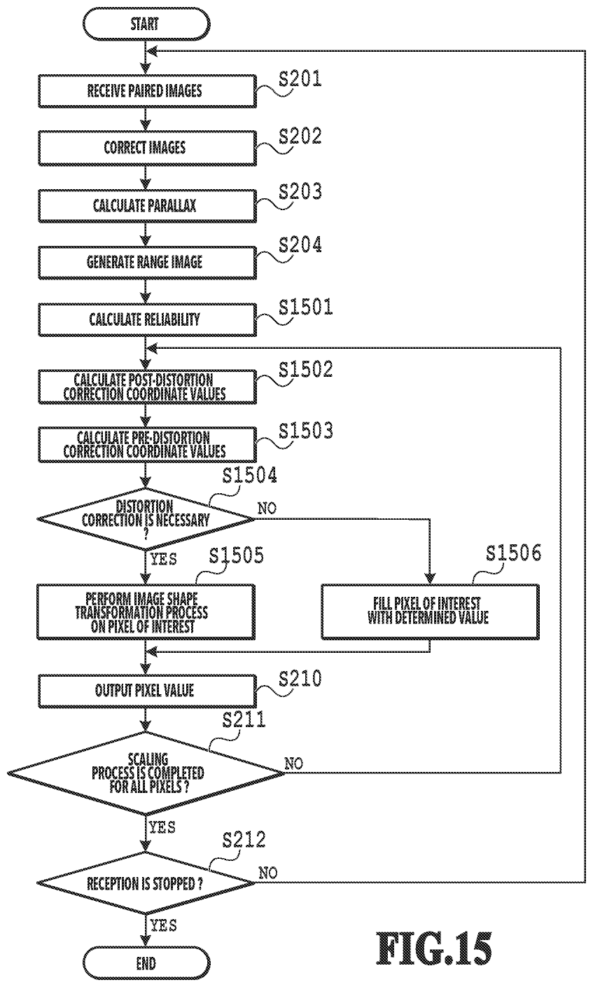

FIG. 15 is an example of a flowchart illustrating a process flow of the range image generation unit 1401 in the distance measuring apparatus 1400 of the embodiment. Functions overlapping those in the aforementioned embodiments are denoted by the same reference numerals.

Since S201 to S204 are the same those in the aforementioned embodiments, description thereof is omitted.

In S1501, a reliability calculation unit 1402 calculates the reliability for each set of predetermined number of pixels in the image corrected in S202. Although the reliability is calculated for each pixel in the embodiment, the reliability may be calculated for each set of any number of pixels. Moreover, although the reliability is calculated in one bit in the embodiment, the reliability may be calculated in any number of bits. The reliability is calculated based on factors that affect the distance measuring accuracy. In the calculation of distance using the phase difference method in the embodiment, the reliability is calculated based on an amount of variation in contrast. The amount of variation in contrast can be calculated from dispersion of pixel values of the point of interest and pixels around the point of interest. The calculated reliability is stored in the SRAM or the like in association with the coordinates in the pre-distortion correction image. The process of S1501 is independent of the processes of S203 to S204 and may be performed in parallel or performed before the process of S203 and the calculated reliability may be stored in advance in the SRAM.

In S1502, the range image read determination unit 1403 refers to the display region information and generates coordinate values in the post-distortion correction image corresponding to each pixel in the display image.

In S1503, the range image read determination unit 1403 refers to the coordinate conversion map and reads coordinate values in the pre-distortion correction image corresponding to the coordinated values in the post-distortion correction image generated in S1502, from the DRAM 110.

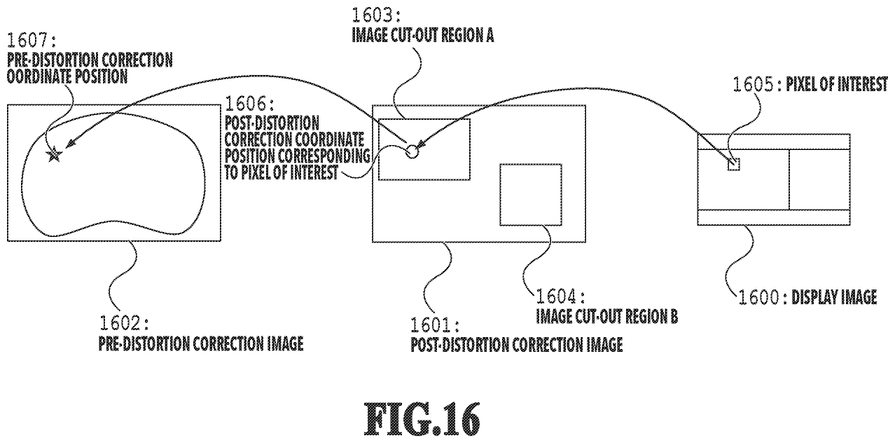

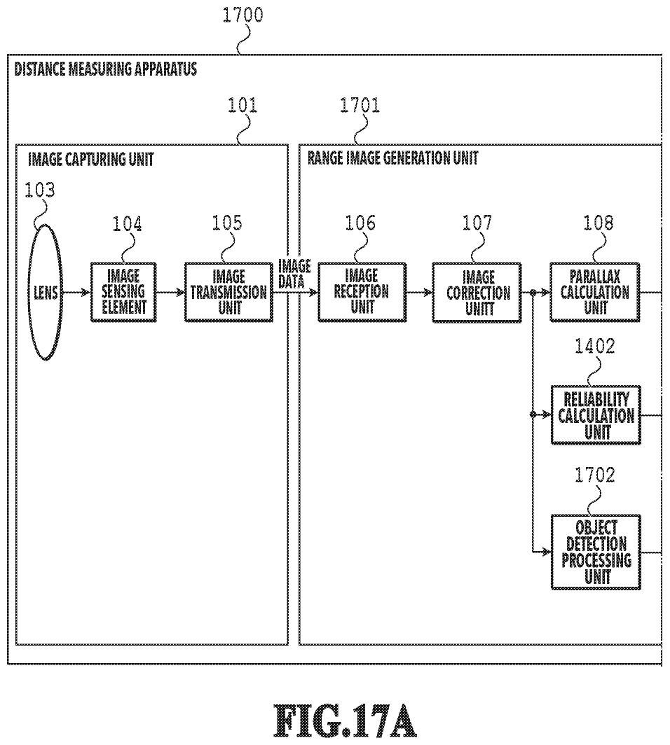

S1502 and S1503 are described by using FIG. 16. FIG. 16 is a view for explaining a method of obtaining the coordinate values in the pre-distortion correction image from the coordinate values in a display image 1600 via a post-distortion correction image 1601 in S1502 and S1503 of the image shape transformation process in Embodiment 5. The display image 1600 displays two image regions (image cut-out region A 1603 and image cut-out region B 1604) cut out from the post-distortion correction image 1601.

The display region information is information specifying the coordinate values of each cut-out region in the post-distortion correction image 1601 in the display image 1600 and may have coordinate values of each pixel in the display image 1600 or may be information indicating a quadrilateral region. For example, in the case where the quadrilateral region has a rectangular shape, the display region information only needs to have start coordinates (X1, Y) of an upper left vertex of the rectangle and end coordinates (X2, Y2) of a lower right vertex.

First, in S1502, the range image read determination unit 1403 refers to the display region information and obtains a post-distortion correction coordinate position 1606 corresponding to a pixel of interest 1605 in the display image 1600. Next, in S1503, the range image read determination unit 1403 refers to the coordinate conversion map and generates a pre-distortion correction coordinate position 1607 corresponding to the post-distortion correction coordinate position 1606. The range image read determination unit 1403 can thereby obtain the pre-distortion correction coordinate position 1607, that is the coordinate values in the pre-distortion correction image corresponding to the pixel of interest 1605 in the display image 1600.

In S1504, the range image read determination unit 1403 reads the reliability corresponding to the pixel closest to the read pre-distortion correction coordinate position 1607, from the SRAM 112. Then, if the reliability is 0, the reading of the range image is determined to be unnecessary and the processing proceeds to S1506. If the reliability is 1, the reading of the range image is determined to be necessary and the processing proceeds to S1505.

Next, in S1505, the image shape transformation unit 1404 reads the pixel value of the pre-distortion correction coordinate position 1607 in the pre-distortion correction image for which the reading of the range image is determined to be necessary in S1504. Then, the image shape transformation process is performed such that the pixel value read by the image shape transformation unit 1404 is set as the pixel value of the point of interest 1605 in the display image.

Meanwhile, in S1506, the image shape transformation unit 1404 does not read the pixel value of the pre-distortion correction coordinate position 1607 in the pre-distortion correction image for which the reading of the range image is determined to be unnecessary in S1504, and does not perform the image shape transformation process. Instead, the masking unit 1405 performs a masking process of assigning a predetermined value to the pixel of the point of interest 1605 in the display image.

In S211, whether pixel values are assigned to all pixels in the display image 1600 by performing either the image shape transformation process or the masking process is determined. If there is a pixel to which no pixel value is assigned, the processing returns to S1502.

The display image subjected to the distortion correction and the processes of cut-out, and scaling can be outputted by repeatedly performing such steps for all pixels in the display image.

In S212, if the reception of the image is not stopped based on, for example, a user input, the processing returns to S201 and the next image is received. Then, the processes of S202 and beyond are executed.

As described above, in the embodiment, even if processes involving access to the DRAM such as scaling of a display region, cut-out of a partial region, multi-screen display performed by specifying multiple regions are performed in addition to the distortion correction process, the used DRAM bandwidth can be reduced by performing control using the reliability.

### Embodiment 6

In Embodiment 6, the used DRAM bandwidth is reduced in a process in which a predetermined subject is detected in a captured image and a range image indicating a distance to this subject is outputted.

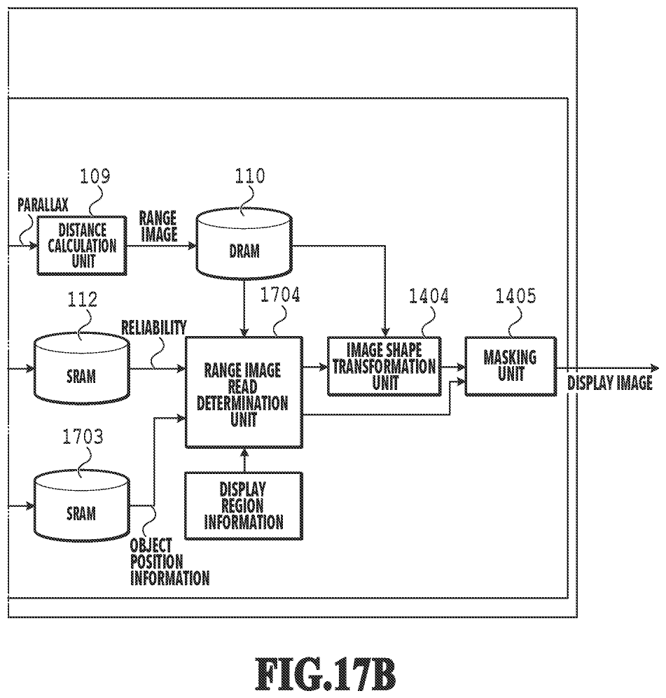

FIGS. 17A and 17B are a diagram illustrating a configuration of a distance measuring apparatus according to Embodiment 6. Functions overlapping those in the aforementioned embodiments are denoted by the same reference numerals and description thereof is omitted.

Reference numeral 1702 denotes an object detection processing unit. The object detection processing unit 1702 performs a process of recognizing and identifying a subject such as character recognition of vehicle numbers and signs and shape recognition of parts by using one of paired captured images outputted from the image correction unit 107 as an input and obtains object position information. There are various methods for the recognition and identification process. The method may be a method of comparing the image with a pattern for a target object stored in advance and calculating similarity or a method of assuming the target object by using a multilayer structure algorithm such as neural network or machine learning that finds and assumes relevance from many pieces of data.

The object position information generated in the object detection processing unit 1702 is information on coordinates indicating an image region corresponding to the subject to be recognized and identified. Reference numeral 1703 denotes an SRAM that stores the object position information calculated for each pixel in the embodiment. The object position information may be information indicating a quadrilateral region including the subject instead information for each pixel. For example, in the case where the quadrilateral region has a rectangular shape, the object position information may hold start coordinates (X1, Y1) of an upper left vertex of the rectangle and end coordinates (X2, Y2) of a lower right vertex for each quadrilateral region. The storage destination of the object position information does not have to be the SRAM and may be other memories.

Reference numeral 1704 denotes a range image read determination unit. In the case where the display region includes an image region corresponding to the subject to be recognized and identified and the reliability is 1, the range image read determination unit 1703 determines that reading of the display region in the range image is necessary depending on the aforementioned display region information, the object position information on the subject to be identified, and the reliability. In the case where the display region includes no image region corresponding to the subject or the reliability is 0, the range image read determination unit 1703 determines that reading of the range image is unnecessary.

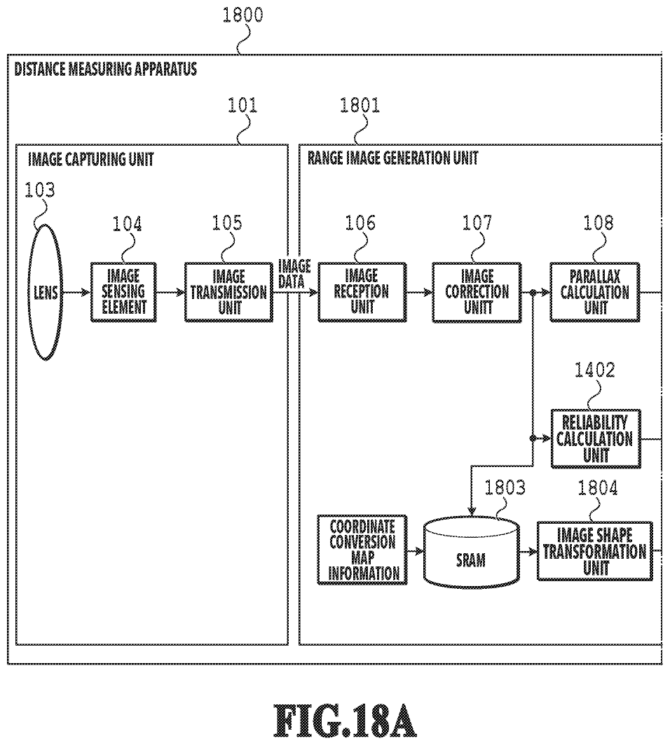

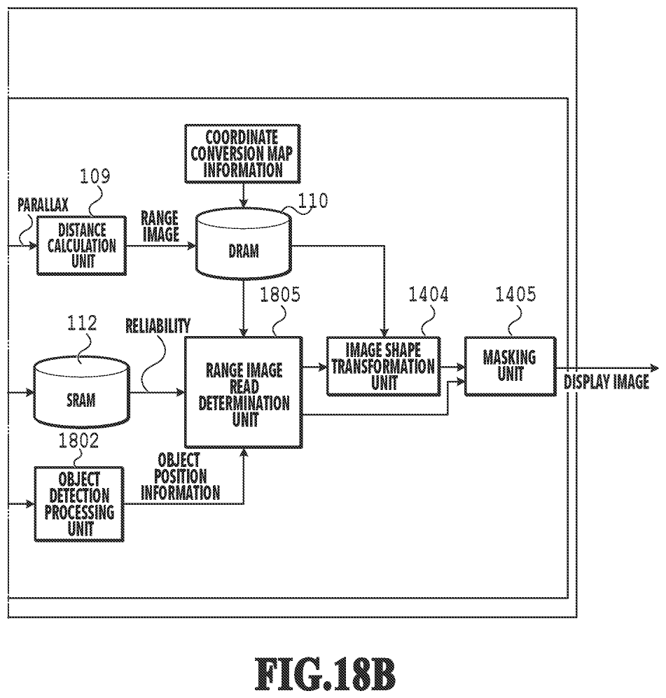

Next, a configuration in which object detection is performed by using the post-distortion correction image and an image region corresponding to a detected subject in the range image is outputted is described as another example of the embodiment. FIG. 18A and 18B are a diagram illustrating another configuration of the distance measuring apparatus according to Embodiment 6 and an image shape transformation unit for distortion correction is added upstream of the object detection processing unit in addition to the image shape transformation unit 1404. Functions overlapping those in the embodiment illustrated in FIG. 17 described above are denoted by the same reference numerals and description thereof is omitted.

Reference numeral 1803 denotes a DRAM that stores image data of one of paired captured images outputted from the image correction unit 107. In the embodiment, image data a out of the image data a and image data b with parallax is assumed to be used. A post-correction image that is the image data a corrected by the image correction unit 107 is referred to as image data A.

Reference numeral 1804 denotes an image shape transformation unit that refers to a coordinate conversion map stored in advance in the DRAM 1803 and generates coordinate values of a pixel in the pre-correction image corresponding to each pixel in the post-distortion correction image. The image shape transformation unit 1804 corrects the distortion of the image data A according to the coordinate conversion map and generates a post-distortion correction image data A′.

Reference numeral 1802 denotes an object detection processing unit. The object detection processing unit 1802 performs a process of recognizing and identifying a subject such as character recognition of vehicle numbers and signs and shape recognition of parts by using the post-distortion correction image data A′ and obtains object position information. A method of the recognition and identification process is as described above. The object position information may be stored in a not-illustrated SRAM.

Note that the same DRAM may be used as the DRAM 1803 that stores the pre-distortion correction image data A and the DRAM 110 that stores the range image. In this case, the same coordinate conversion map can be referred to. Moreover, coordinate conversion map information in which the coordinate values are set such that the image data is resized in advance into an image data size handled in the object detection processing unit 1802 may be stored in the DRAM 1803.

Reference numeral 1805 denotes a range image read determination unit. The range image read determination unit 1805 refers to the object position information generated by the object detection processing unit 1802 and the reliability calculated by the reliability calculation unit 1402 and determines that a pixel value for coordinates indicated by the object position information in the range image needs to be read in the case where the coordinates indicate an image region corresponding to the subject to be recognized and identified and the reliability corresponding to the coordinates is 1.

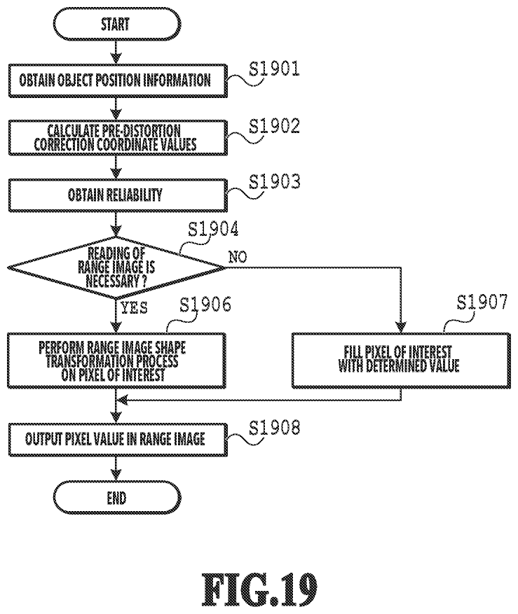

FIG. 19 is a flowchart illustrating an example of a flow from range image read determination performed by the range image read determination unit 1805 in the distance measuring apparatus 1800 of the embodiment to image shape transformation process of the range image.

In S1901, the range image read determination unit 1805 obtains the object position information generated by the object detection processing unit 1802. The object position information is information indicating the coordinates of the image region corresponding to the subject. The object position information may be information indicating presence or absence of the subject for each pixel in one bit (1 in the case where the subject present and 0 in the case where the subject is absent) and read from the not-illustrated SRAM or information indicating a quadrilateral region including the image region corresponding to the subject. For example, in the case where the quadrilateral region has a rectangular shape, the object position information is information having start coordinates (X1, Y1) of an upper left vertex of the rectangle and end coordinates (X2, Y2) of a lower right vertex.

In S1902, the range image read determination unit 1805 refers to the coordinate conversion map of the range image in the DRAM 110, selects a pixel of interest from pixels corresponding to the coordinates indicated by the object position information, and generates a pre-distortion correction coordinate position corresponding to the selected pixel of interest.

In S1903, the range image read determination unit 1805 reads reliability of a pixel closest to the read pre-distortion correction coordinate position, from the SRAM 112. If the reliability is 0, the reading of the range image is determined to be unnecessary and the processing proceeds to S1907. If the reliability is 1, the reading of the pixel value is determined to be necessary for the pixel of interest in the range image and the processing proceeds to S1906.

Next, in S1906, the image shape transformation unit 1404 performs reading of a corresponding pixel value in the pre-distortion correction image and the image shape transformation process, for the pixel of interest in the range image for which reading is determined to be necessary in S1903. Meanwhile, in S1907, no reading of the pre-distortion correction image or the image shape transformation process is performed for the pixel for which reading of the range image is determined to be unnecessary in S903 and the masking unit 1405 performs the masking process of assigning a predetermined value to this pixel.

In S1908, the pixel value of the range image processed in S1906 or S1907 is outputted. Repeatedly executing the process flow described by using FIG. 19 for all coordinates indicated by the object position information enables output of the range image only for the subject to be identified.

As described above, according to the embodiment, the used DRAM bandwidth can be reduced in the process in which an image region corresponding to a subject in a predetermined display region is detected and the range image is outputted only for this subject. This is because the embodiment can limit the pixel values of the range image read from the DRAM by using the reliability and the object position information of the subject.

Note that, also in the case where the object position information of the subject is obtained from the outside of the distance measuring apparatus, the pixel values of the range image read from the DRAM can be limited by using the reliability of each pixel and the object position information of the subject as in the above description. Although the distance measuring apparatus is configured to generate the object position information in the embodiment, an external apparatus may generate the object position information. For example, the configuration may be such that the image transmission unit 105 or the image correction unit 107 outputs the captured image to the external apparatus (GPU or the like) and the range image read determination unit 1705, 1805 obtains the detection result of the image region corresponding to the subject in the captured image obtained by the external apparatus as the object position information.

### Embodiment 7

In Embodiment 7, the used DRAM bandwidth is reduced in a process in which two range images generated by two distance measuring apparatuses to have overlapping distance measuring regions, specifically two range images generated based on captured images having overlapping captured image regions are synthesized and outputted as one synthesized range image.

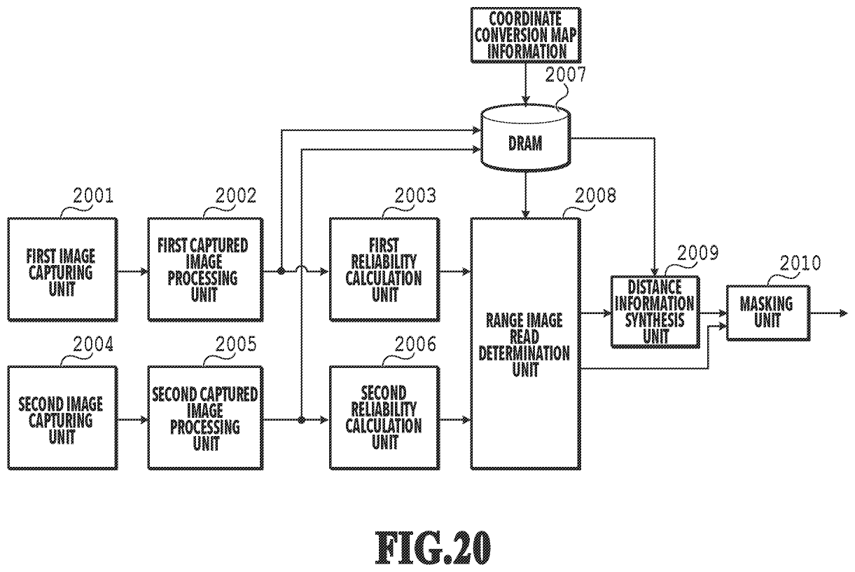

FIG. 20 is a diagram illustrating a configuration of a distance measuring apparatus according to Embodiment 7.

Reference numeral 2001 denotes a first image capturing unit that includes a lens and an image sensing element and that outputs image data generated by the image sensing element.

Reference numeral 2002 denotes a first captured image processing unit that receives the image data from the first image capturing unit 2001 and processes the image data. The first captured image processing unit 2002 includes an image correction unit, a parallax calculation unit, and a distance calculation unit. The first captured image processing unit 2002 generates a range image (range image 1) by using the captured image data and writes the range image 1 into a DRAM 2007.

Reference numeral 2003 denotes a first reliability calculation unit that calculates reliability of a range (reliability 1) based on a post-image correction image data obtained from the first captured image processing unit. A method of calculating the reliability is as described in the aforementioned embodiments.

Reference numeral 2004 denotes a second image capturing unit that includes a lens and an image sensing element and that outputs image data generated by the image sensing element.

Reference numeral 2005 denotes a second captured image processing unit that receives the image data from the second image capturing unit 2004 and processes the image data. The second captured image processing unit 2005 includes an image correction unit, a parallax calculation unit, and a distance calculation unit. The second captured image processing unit 2005 generates a range image (range image 2) by using the captured image data and writes the range image 2 into the DRAM 2007.

Reference numeral 2006 denotes a second reliability calculation unit that calculates reliability of a distance (reliability 2) based on a post-image correction image data obtained from the second captured image processing unit. A method of calculating the reliability is as in the aforementioned embodiments.

Reference numeral 2008 is a range image read determination unit. The range image read determination unit 2008 generates coordinate values in the range images 1 and 2 corresponding to each pixel in the display image. Specifically, the range image read determination unit 2008 refers to coordinate conversion maps for associating coordinates in the pre-distortion correction range image and the post-distortion correction range image which are stored in advance in the DRAM 2007 and which correspond to the range images 1 and 2, respectively, and generates coordinate values of each pixel. The range image read determination unit 2008 obtains reliability corresponding to a pixel closest to the generated coordinate values from each of the first reliability calculation unit and the second reliability calculation unit.

In the case where there is an overlapping region between the range image 1 and the range image 2, the range image read determination unit 2008 determines a degree of reliability (whether the reliability is high or low) in each of the range images and instructs a distance information synthesis unit 2009 to read a pixel value in the range image with higher reliability. In the case where the reliability is 0 in both range images, the range image read determination unit 2008 determines that reading of the range image is unnecessary and a masking unit 2010 performs a masking process (sets a predetermined value for the pixel in the display image and output the value). In the case where the reliability is the same value other than 0 in both images, the range image read determination unit 2008 may instruct the distance information synthesis unit 2009 to read the pixels value in either of the range images. Note that, in such a case, effects of optical distortion can be reduced by reading a pixel value in a range image with a smaller distance between the pixel for which the reliability is calculated and an optical axis center of the first image capturing unit 2001 or the second image capturing unit 2004

The distance information synthesis unit 2009 reads the range image generated by one of a set of the first image capturing unit 2001 and the first captured image processing unit 2002 and a set of the second image capturing unit 2004 and the second captured image processing unit 2005, depending on the instruction from the range image read determination unit 2008. Note that the distance information synthesis unit 2009 may perform an interpolation process for improving image quality as in the aforementioned embodiments.

Although the configuration including two image capturing units 2001 and 2004 as illustrated in FIG. 20 is described above as the hardware configuration of the distance measuring apparatus according to Embodiment 7, this embodiment can be similarly applied to the case where three or more image capturing units are used.

As described above, according to the embodiment, the used DRAM bandwidth can be reduced by limiting the pixel values in the range image read from the DRAM based on the reliability of each pixel in the case where range images from multiple cameras capable of measuring a distance are synthesized and displayed. Distortion correction of correcting optical distortion can be performed in the synthesis of the range images and the used DRAM bandwidth can be similarly reduced. Note that, in the overlapping region between multiple range images to be synthesized, the distortion correction may be performed only on the range image with the highest reliability. This can reduce the used DRAM bandwidth from the case where the distortion correction is performed on all range images.

Moreover, in the aforementioned embodiment, the method in which multiple photodiodes are arranged for one distance measuring pixel and a distance is calculated by using the phase difference method and the method using the stereo camera are described as the distance measuring methods. However, the present invention is not limited to these distance measuring methods and can be applied also to a transformation process performed in the case where distance information obtained by TOF, a millimeter wave radar, light detection and distance measuring (LiDAR), and the like is visualized and displayed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention can reduce the memory bandwidth required to calculate the distance information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2020-025037, filed Feb. 18, 2020, and No. 2020-209189, filed Dec. 17, 2020, which are hereby incorporated by reference wherein in their entirety.

What is claimed is:

1. A generation apparatus that generates a range image indicating a distance to a subject, comprising:
a generation unit configured to generate the range image based on a pair of captured images with parallax; and
a correction unit configured to correct distortion, caused by an optical system of an image capturing unit generating the pair of captured images, in a region of the range image, the region being a region in which reliability is a predetermined threshold or more.

2. A generation apparatus that generates a range image indicating a distance to a subject, comprising:
a correction unit configured to correct distortion, caused by an optical system of an image capturing unit generating a pair of captured images with parallax, in regions of the pair of captured images, the regions being regions in which reliability is a predetermined threshold or more; and
a generation unit configured to generate the range image based on the pair of captured images in which the distortion is corrected by the correction unit.

3. The generation apparatus according to claim 1, wherein the correction unit calculates the reliability based on pixel values of a pixel of interest and pixels around the pixel of interest.

4. The generation apparatus according to claim 1, wherein the reliability is an amount of variation in contrast calculated based on dispersion of pixel values of a pixel of interest and pixels around the pixel of interest.

5. The generation apparatus according to claim 1, wherein the correction unit applies different predetermined distortion correction methods depending on a proportion of a region in which the reliability is less than the predetermined threshold.

6. The generation apparatus according to claim 1, further comprising a masking unit configured to set a predetermined value for a pixel in a region in which the reliability is less than the predetermined threshold.

7. The generation apparatus according to claim 1, further comprising a selection unit configured to select a process based on a predetermined access bandwidth to a storage unit configured to store at least the range image and a proportion of the region in which the reliability is the predetermined threshold or more, the process involving access to the storage unit at the predetermined access bandwidth or less.

8. The generation apparatus according to claim 7, wherein
the selection unit selects one of a plurality of predetermined distortion correction methods based on a proportion of a region in which the reliability is the predetermined threshold or less and access bandwidths to the storage unit required for the respective predetermined distortion correction methods, and
the correction unit applies the distortion correction method selected by the selection unit.

9. The generation apparatus according to claim 8, wherein the selection unit selects one of a plurality of predetermined additional processes based on the predetermined access bandwidth, the proportion of the region in which the reliability is less than the predetermined threshold, the access bandwidth to the storage unit required for the selected distortion correction method, and access bandwidths to the storage unit required for the respective predetermined additional processes.

10. The generation apparatus according to claim 8, wherein the selection unit selects one of the plurality of predetermined distortion correction methods that vary in pixels referred to in interpolation of pixel values in the distortion correction

11. The generation apparatus according to claim 1, wherein
the storage unit includes a cache unit that has a buffer capable of storing pixel values of a predetermined number of pixels and that performs replacement of the pixel values in a unit of the buffer, and
the correction unit calculates the reliability for each set of pixels corresponding to the buffer and obtains the pixel values for which the distortion correction is to be performed from the cache unit.

12. The generation apparatus according to claim 1, further comprising a specification unit configured to specify a portion of the range image as a cut-out region, wherein
the correction unit corrects the distortion based on the cut-out region and the region in which the reliability is the predetermined threshold or more.

13. The generation apparatus according to claim 12, wherein the cut-out region is an image region corresponding to a predetermined object in the captured images.

14. The generation apparatus according to claim 1, further comprising a synthesis unit configured to generate a synthesized range image by synthesizing a plurality of the range images which are generated based on a plurality of the pairs of the captured images with overlapping captured image regions and which have overlapping regions, wherein
the synthesis unit uses a pixel value of the range image in which the reliability of the overlapping region is the highest, among pixel values of the overlapping regions of the plurality of range images, as a pixel value of a region corresponding to the overlapping region in the synthesized range image.

15. The generation apparatus according to claim 14, wherein the correction unit corrects the distortion in the range image in which the reliability of the overlapping region is the highest, for the overlapping regions in the regions in which the reliability is the threshold or more in the respective range images.

16. A generation method of generating a range image indicating a distance to a subject, comprising:
a generation step of generating the range image based on a pair of captured images with parallax; and
a correction step of correcting distortion, caused by an optical system of an image capturing unit generating the pair of captured images, in a region of the range image, the region being a region in which reliability is a predetermined threshold or more.

17. A generation method of generating a range image indicating a distance to a subject, comprising:
a correction step of correcting distortion, caused by an optical system of an image capturing unit generating a pair of captured images with parallax, in regions of the pair of captured images, the regions being regions in which reliability is a predetermined threshold or more; and
a generation step of generating the range image based on the pair of captured images in which the distortion is corrected in the correction step.

18. A non-transitory computer readable storage medium storing a program that causes a computer to execute a generation method of generating a range image indicating a distance to a subject, the generation method comprising:
a generation step of generating the range image based on a pair of captured images with parallax; and
a correction step of correcting distortion, caused by an optical system of an image capturing unit generating the pair of captured images, in a region of the range image, the region being a region in which reliability is a predetermined threshold or more.

19. A non-transitory computer readable storage medium storing a program that causes a computer to execute a generation method of generating a range image indicating a distance to a subject, the generation method comprising:
a correction step of correcting distortion, caused by an optical system of an image capturing unit generating a pair of captured images with parallax, in regions of the pair of captured images, the regions being regions in which reliability is a predetermined threshold or more; and
a generation step of generating the range image based on the pair of captured images in which the distortion is corrected in the correction step.
